(19) United States
(12) Patent Application Publication
(10) Pub. No.: US 2026/0023834 A1
(43) Pub. Date: Jan. 22, 2026

(54) INFORMATION PROCESSING APPARATUS FOR TWO-STAGE AUTHENTICATION, METHOD FOR CONTROLLING INFORMATION PROCESSING APPARATUS, AND STORAGE MEDIUM

(71) Applicant: CANON KABUSHIKI KAISHA, Tokyo (JP)

(72) Inventors: KOICHIRO NAKAMURA, Tokyo (JP); TOMOAKI KAWAI, Kanagawa (JP)

(21) Appl. No.: 19/269,806

(22) Filed: Jul. 15, 2025

(30) Foreign Application Priority Data
Jul. 17, 2024 (JP) 2024-114159

(51) Int. Cl. G06F 21/32

(52) U.S. Cl. CPC G06F 21/32

(57) ABSTRACT

An information processing apparatus configured to perform user authentication includes a management unit configured to manage authentication registration information about a user to permit use of the information processing apparatus, and an authentication unit configured to perform authentication of an authentication target user by using a plurality of pieces of authentication target information acquired from a plurality of different parts of the authentication target user and the authentication registration information.

### BACKGROUND

### Field of the Technology

The present disclosure relates to an information processing apparatus for two-stage authentication, a method for controlling an information processing apparatus, and a storage medium.

### Description of the Related Art

There are methods for performing personal authentication of users on information processing apparatuses. For example, Japanese Patent Application Laid-Open No. 2024-2562 discusses a method for performing personal authentication on a user by using an eye image when the user looks into a viewfinder.

In general, personal authentication of a user of an information processing apparatus is performed by setting an extremely low false acceptance rate to prevent the user from being erroneously identified as another person. However, setting such a low false acceptance rate increases a false rejection rate. This leads to an issue of lower usability since false rejection occurs frequently when user authentication is performed in using the information processing apparatus.

### SUMMARY

The present disclosure is directed to improving the accuracy of user authentication by an information processing apparatus so that a decrease in usability can be prevented.

According to an aspect of the present disclosure, an information processing apparatus configured to perform user authentication includes a management unit configured to manage authentication registration information about a user to permit use of the information processing apparatus, and an authentication unit configured to perform authentication of an authentication target user by using a plurality of pieces of authentication target information acquired from a plurality of different parts of the authentication target user and the authentication registration information.

Features of the present disclosure will become apparent from the following description of embodiments with reference to the attached drawings. The following description of embodiments are described by way of example.

### BRIEF DESCRIPTION OF THE DRAWINGS

FIGS. 1A and 1B are diagrams illustrating an example of appearance of a camera corresponding to an information processing apparatus according to a first exemplary embodiment.

FIG. 2 is a diagram illustrating an example of an internal mechanism of the camera corresponding to the information processing apparatus according to the first exemplary embodiment.

FIG. 3 is a diagram illustrating an example of an electrical configuration of the camera corresponding to the information processing apparatus according to the first exemplary embodiment.

FIGS. 4A to 4D are diagrams illustrating the first exemplary embodiment, illustrating a display example of a screen of a display device.

FIG. 5A is a diagram illustrating an example of a functional configuration of the camera corresponding to the information processing apparatus according to the first exemplary embodiment.

FIG. 5B is a diagram illustrating the first exemplary embodiment, illustrating an example of various tables managed by a registration data management unit illustrated in FIG. 5A.

FIG. 5C is a diagram illustrating the first exemplary embodiment, illustrating an example of the various tables managed by the registration data management unit illustrated in FIG. 5A.

FIG. 5D is a diagram illustrating the first exemplary embodiment, illustrating an example of the various tables managed by the registration data management unit illustrated in FIG. 5A.

FIG. 5E is a diagram illustrating the first exemplary embodiment, illustrating an example of the various tables managed by the registration data management unit illustrated in FIG. 5A.

FIG. 5F is a diagram illustrating the first exemplary embodiment, illustrating an example of the various tables managed by the registration data management unit illustrated in FIG. 5A.

FIG. 6A is a flowchart illustrating an example of a detailed processing procedure for registration processing in a method for controlling the camera corresponding to the information processing apparatus according to the first exemplary embodiment.

FIG. 6B is a flowchart subsequent to that of FIG. 6A, illustrating the example of the detailed processing procedure for the registration processing in the method for controlling the camera corresponding to the information processing apparatus according to the first exemplary embodiment.

FIG. 7 is a flowchart illustrating an example of a detailed processing procedure for eye image acquisition processing in step S604 of FIG. 6A.

FIG. 8A is a flowchart illustrating an example of a detailed processing procedure for first authentication processing in the method for controlling the camera corresponding to the information processing apparatus according to the first exemplary embodiment.

FIG. 8B is a flowchart subsequent to that of FIG. 8A, illustrating the example of the detailed processing procedure for the first authentication processing in the method for controlling the camera corresponding to the information processing apparatus according to the first exemplary embodiment.

FIG. 9 is a flowchart illustrating an example of a detailed processing procedure for second authentication processing in the method for controlling the camera corresponding to the information processing apparatus according to the first exemplary embodiment.

FIG. 10 is a flowchart illustrating an example of a detailed processing procedure for other person use detection processing in step S916 of FIG. 9.

FIG. 11A is a flowchart illustrating an example of a detailed processing procedure for first authentication invalidation processing in the method for controlling the camera corresponding to the information processing apparatus according to the first exemplary embodiment.

FIG. 11B is a flowchart illustrating an example of the detailed processing procedure for the first authentication invalidation processing in the method for controlling the camera corresponding to the information processing apparatus according to the first exemplary embodiment.

FIG. 11C is a flowchart illustrating an example of the detailed processing procedure for the first authentication invalidation processing in the method for controlling the camera corresponding to the information processing apparatus according to the first exemplary embodiment.

FIG. 11D is a flowchart illustrating an example of the detailed processing procedure for the first authentication invalidation processing in the method for controlling the camera corresponding to the information processing apparatus according to the first exemplary embodiment.

FIG. 12A is a flowchart illustrating an example of a detailed processing procedure for authentication state storage processing in the method for controlling the camera corresponding to the information processing apparatus according to the first exemplary embodiment.

FIG. 12B is a diagram illustrating the first exemplary embodiment, illustrating a configuration example of an image file stored by an authentication state storage unit.

FIG. 13 is a diagram illustrating the first exemplary embodiment, a diagram for describing the principle of user's line of sight detection processing.

FIGS. 14A and 14B are diagrams illustrating the first exemplary embodiment, diagrams for describing the user's line of sight detection processing.

FIG. 15 is a flowchart illustrating an example of a detailed processing procedure for the line of sight detection processing in the method for controlling the camera corresponding to the information processing apparatus according to the first exemplary embodiment.

### DESCRIPTION OF THE EMBODIMENTS

Modes (exemplary embodiments) for carrying out the present disclosure will be described with reference to the drawing.

A first exemplary embodiment will initially be described.

### [Camera Configuration]

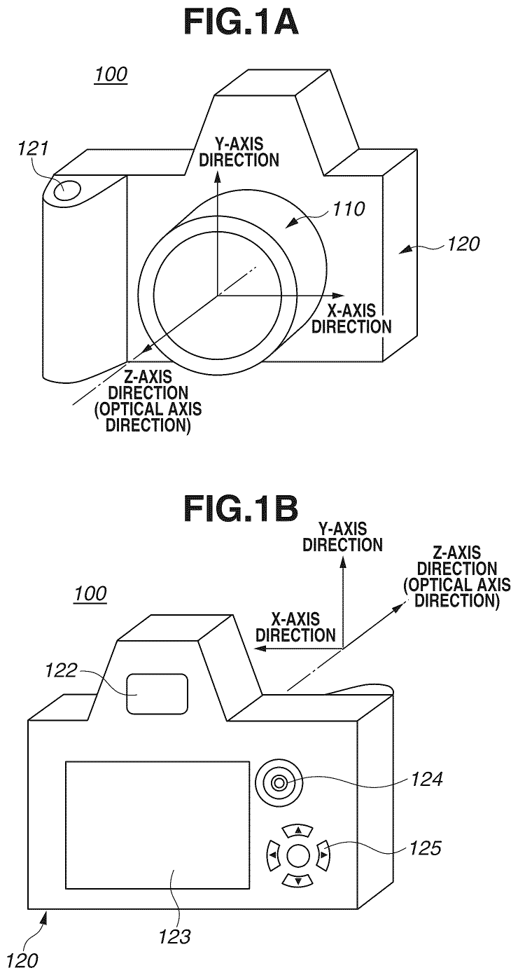

FIGS. 1A and 1B are diagrams illustrating an example of appearance of a camera 100 corresponding to an information processing apparatus according to the first exemplary embodiment. Specifically, for example, an interchangeable-lens digital still camera can be applied as the camera 100 corresponding to the information processing apparatus according to the present exemplary embodiment. FIG. 1A is a perspective front view illustrating the example of the appearance of the camera 100 according to the first exemplary embodiment. FIG. 1B is a perspective rear view illustrating the example of the appearance of the camera 100 according to the first exemplary embodiment. In FIGS. 1A and 1B, similar components are denoted by the same reference numerals. FIGS. 1A and 1B illustrate an XYZ coordinate system with an optical axis direction of the camera 100 as a Z-axis direction, and two mutually orthogonal directions orthogonal to the Z-axis direction as X- and Y-axis directions.

As illustrated in FIG. 1A, the camera 100 includes an imaging lens unit 110 and a camera housing 120. A release button 121, which is an operation member for accepting imaging operations from the user (photographer), is disposed on the front of the camera housing 120.

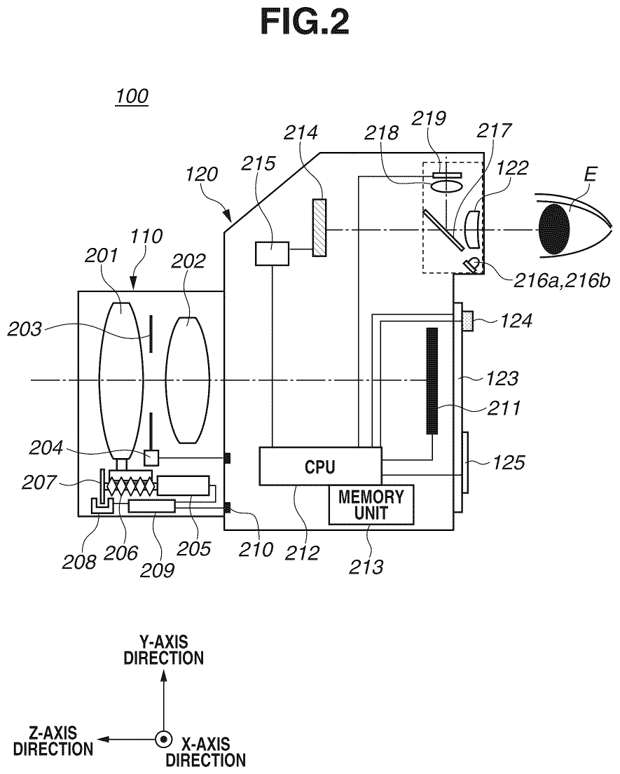

As illustrated in FIG. 1B, an eyepiece lens 122 (viewfinder) for the user to look into to view a display device (display device 214 of FIG. 2 to be described below) included inside the camera housing 120 is disposed on the rear of the camera housing 120. Operation members 123 to 125 for accepting various operations from the user are also disposed on the rear of the camera housing 120. For example, the operation member 123 is a touchscreen for accepting touch operations. The operation member 124 is an operation lever that can be tilted in various directions. The operation member 125 is a four-way directional pad that can be pressed in each of four directions. The operation member 123 that is a touchscreen includes a display panel (such as a liquid crystal panel) and has a function of displaying various images on the display panel.

FIG. 2 is a diagram illustrating an example of an internal mechanism of the camera 100 corresponding to the information processing apparatus according to the present exemplary embodiment. Specifically, FIG. 2 is a sectional view of the camera 100, taken along a YZ plane formed by the Y- and Z-axis directions illustrated in FIG. 1A. In this FIG. 2, components similar to those illustrated in FIGS. 1A and 1B are denoted by the same reference numerals. A detailed description thereof will be omitted. FIG. 2 illustrates the XYZ coordinate system corresponding to that illustrated in FIGS. 1A and 1B.

The imaging lens unit 110 includes, as its internal mechanism, lenses 201 and 202, a diaphragm 203, a diaphragm driving unit 204, a lens driving motor 205, a lens driving member 206, a pulse plate 207, a photocoupler 208, a focus adjustment circuit 209, and mount contacts 210.

The lens driving member 206 includes a driving gear. The photocoupler 208 detects rotation of the pulse plate 207 that moves with the lens driving member 206, and transmits the detected information to the focus adjustment circuit 209. The focus adjustment circuit 209 drives the lens driving motor 205 based on the information from the photocoupler 208 and the information (information about the amount of lens driving) from the camera housing 120, thereby moving the lens 201 to change the in-focus position. The mount contacts 210 are an interface between the imaging lens unit 110 and the camera housing 120. In FIG. 2, the two lenses 201 and 202 are illustrated for the same of simplicity. In fact, the imaging lens unit 110 includes more than two lenses.

The camera housing 120 includes, as its internal mechanism, an image sensor 211, a central processing unit (CPU) 212, a memory unit 213, a display device 214, a display device driving circuit 215, light sources 216a and 216b, a beam splitter 217, a light receiving lens 218, and an eye image sensor 219.

The image sensor 211 is located at an intended image forming plane of the imaging lens unit 110. The CPU 212 is a microcomputer CPU, and controls operation of the entire camera 100 and performs various types of processing. The memory unit 213 stores various types of information and programs for the CPU 212 to execute in performing various types of processing. For example, the memory unit 213 stores object images captured by the image sensor 211. The display device 214 displays various types of information on a screen (display surface) of the display device 214. For example, the display device 214 is a liquid crystal panel and displays captured images (object images) on its screen. The display device driving circuit 215 drives the display device 214. The user's (photographer's) eye E can view the screen of the display device 214 through the eyepiece lens 122.

The light sources 216a and 216b are light sources conventionally used in single-lens reflex cameras to detect the line of sight of the eye E from a relationship between a reflection image (corneal reflection image) formed by the corneal reflection of light and the pupil. Specifically, the light sources 216a and 216b are light sources for illuminating the user's eye E looking into the viewfinder (eyepiece lens 122). For example, the light sources 216a and 216b are infrared light-emitting diodes that emit infrared rays imperceptible to the user's eye E, and arranged around the eyepiece lens 122. An optical image of the eye E illuminated by the light sources 216a and 216b (eye optical image; an optical image formed by the light emitted from the light sources 216a and 216b and reflected at the eye E) is transmitted through the eyepiece lens 122 and reflected at the beam splitter 217. The eye optical image is formed on the eye image sensor 219, where a plurality of photoelectric conversion elements (such as charge-coupled device [CCD] elements and complementary metal-oxide-semiconductor [CMOS] elements) is two-dimensionally disposed, by the light receiving lens 218. The light receiving lens 218 positions the pupil of the user's eye E and the eye image sensor 219 in a conjugate imaging relationship. Through line of sight detection processing, the line of sight of the eye E is detected from the position of the corneal reflection image on the eye optical image formed on the eye image sensor 219. For example, as information about the line of sight, at least either information indicating the line of sight direction or information indicating the point of fixation (point to which the line of sight is directed) on the screen of the display device 214 is obtained.

The point of fixation may be regarded as the position where the user is looking at, or as a line of sight position.

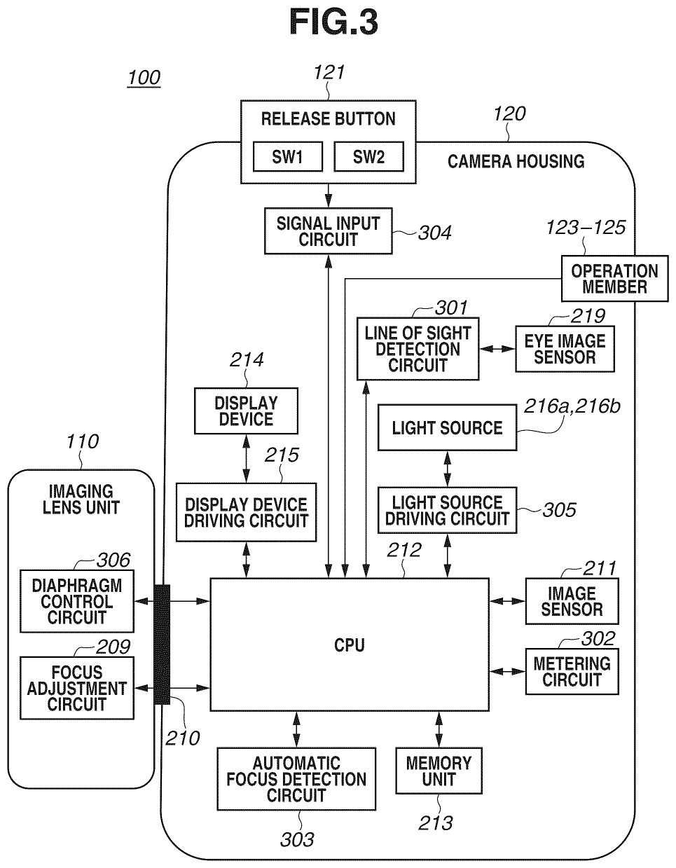

FIG. 3 is a diagram illustrating an example of an electrical configuration of the camera 100 corresponding to the information processing apparatus according to the first exemplary embodiment. In this FIG. 3, components similar to those illustrated in FIGS. 1 and 2 are denoted by the same reference numerals. A detailed description thereof will be omitted.

The imaging lens unit 110 includes, as its electrical components, the focus adjustment circuit 209 illustrated in FIG. 2 and a diaphragm control circuit 306.

The camera housing 120 includes, as its electrical components, the release button 121 and the operation members 123 to 125 illustrated in FIG. 1. The camera housing 120 further includes, as its electrical components, the image sensor 211, the CPU 212, the memory unit 213, the display device 214, the display device driving circuit 215, the light sources 216a and 216b, and the eye image sensor 219 illustrated in FIG. 2. The camera housing 120 further includes, as its electrical components, a line of sight detection circuit 301, a metering circuit 302, an automatic focus detection circuit 303, a signal input circuit 304, and a light source driving circuit 305 as illustrated in FIG. 3.

As illustrated in FIG. 3, the CPU 212 is connected to the line of sight detection circuit 301, the metering circuit 302, the automatic focus detection circuit 303, the signal input circuit 304, the light source driving circuit 305, the image sensor 211, the display device driving circuit 215, the memory unit 213, and the operation members 123 to 125. The CPU 212 transmits signals to the focus adjustment circuit 209 disposed in the imaging lens unit 110 and the diaphragm control circuit 306 included in the diaphragm driving unit 204 in the imaging lens unit 110 via the mount contacts 210. The memory unit 213 accompanying the CPU 212 has a storage function of storing imaging signals from the image sensor 211 and the eye image sensor 219, for example.

The line of sight detection circuit 301 performs analog-to-digital (A/D) conversion on the output of the eye image sensor 219 (captured eye image of the user's eye E) in a state where an eye optical image is formed on the eye image sensor 219, and transmits the result to the CPU 212. The CPU 212 extracts feature points for use in line of sight detection from the eye image based on the line of sight detection processing, and detects the user's line of sight from the positions of the feature points.

The metering circuit 302 performs predetermined processing (for example, amplification, logarithmic compression, and A/D conversion) on a signal obtained from the image sensor 211 serving also as a metering sensor, such as a luminance signal corresponding to the brightness of the field of view. The metering circuit 302 transmits the processing result to the CPU 212 as field of view luminance information.

The automatic focus detection circuit 303 performs A/D conversion on signals from a plurality of detection elements (plurality of pixels) for use in phase difference detection, included in the image sensor 211, and transmits the A/D-converted signals to the CPU 212. The CPU 212 calculates the distances to objects corresponding to respective focus detection points from the signals of the plurality of detection elements. This is a conventional technique known as image plane phase-difference AF.

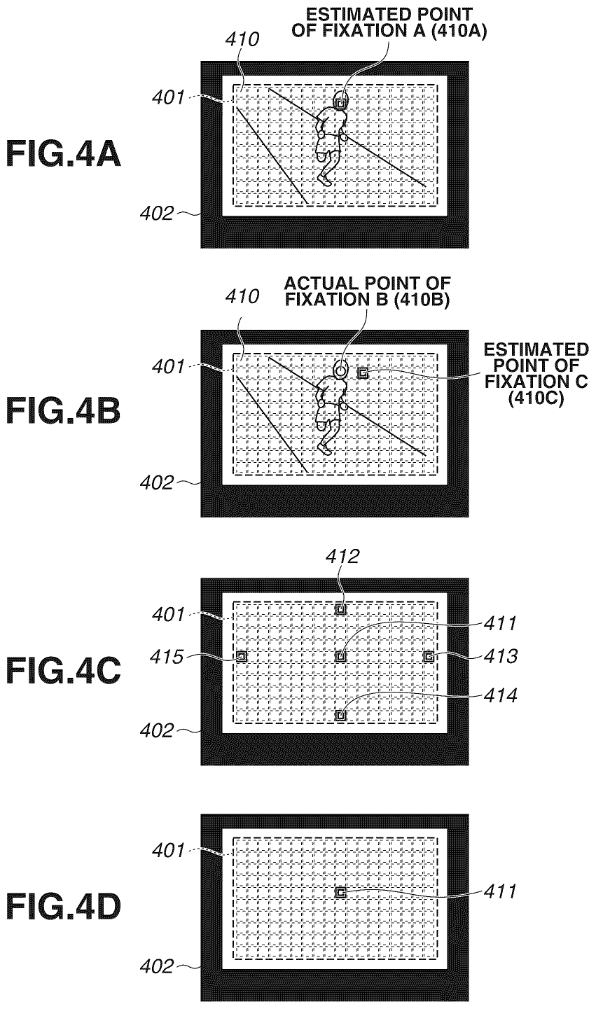

FIGS. 4A to 4D are diagrams illustrating the first exemplary embodiment, illustrating display examples of the screen of the display device 214.

For example, in the present exemplary embodiment, the focus detection points described in conjunction with the automatic focus detection circuit 303 are located at 180 positions on the imaging plane, corresponding to respective 180 locations indicated on the screen of the display device 214 (intra-viewfinder field of view) illustrated in FIG. 4A. FIG. 4A illustrates a state where the display device 214 is in operation (state where an image is displayed). The intra-viewfinder field of view includes a focus detection region 401, a field of view mask 402, and 180 ranging point indices 410 within the focus detection region 401. The ranging point indices 410 illustrated in FIG. 4A are superimposed on a through image (live-view image) displayed on the display device 214 so that the ranging point indices 410 are displayed at the positions corresponding to the respective focus detection points on the imaging plane. Of the 180 ranging point indices 410 illustrated in FIG. 4A, a ranging point index 410A corresponding to the current point of fixation A (estimated position) is highlighted with a frame, for example. Now, return to the description of FIG. 3.

A switch SW1 and a switch SW2 of the release button 121 are connected to the signal input circuit 304. The switch SW1 is a switch that is turned on by a first stroke of the release button 121 to start imaging preparation operations of the camera 100 (such as metering and ranging).

The switch SW2 is a switch that is turned on by a second stroke of the release button 121 to start imaging operations. When ON signals from the switches SW1 and SW2 of the release button 121 are input to the signal input circuit 304, the signal input circuit 304 transmits the input ON signals to the CPU 212. The detection of the user's line of sight may be started when the switch SW1 of the release button 121 is turned on. The light source driving circuit 305 drives the light sources 216a and 216b.

When the user operates the operation members 123 to 125, the operation members 123 to 125 output operation signals based on the user's operation to the CPU 212. The CPU 212 performs processing (control) based on the operation signals. For example, the CPU 212 moves a selection frame on a displayed menu based on the operation signals.

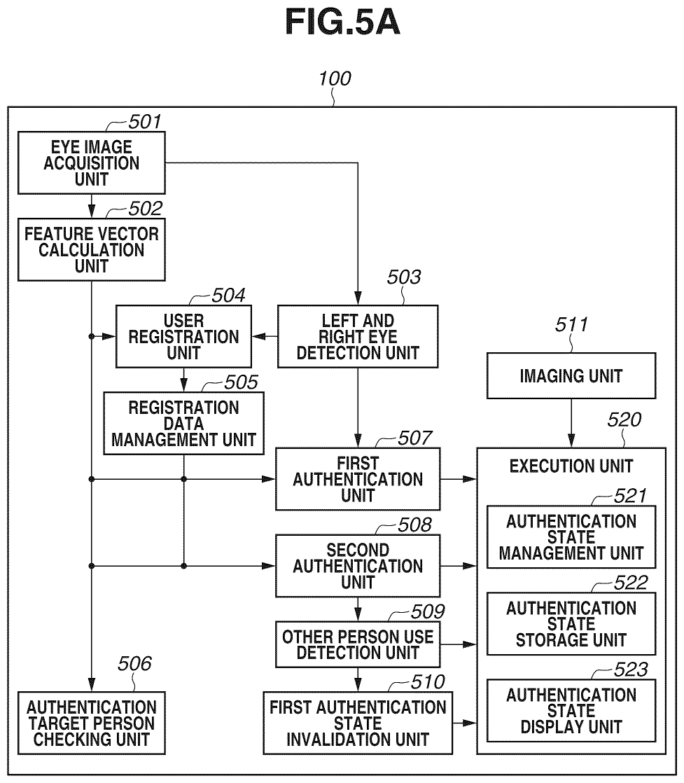

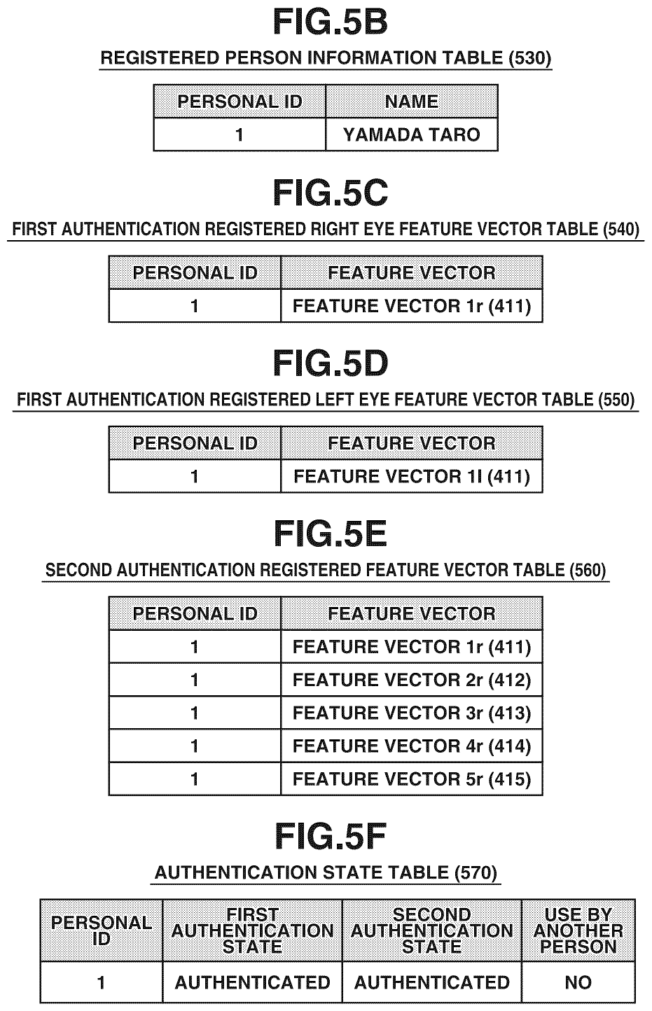

FIG. 5A is a diagram illustrating an example of a functional configuration of the camera 100 corresponding to the information processing apparatus according to the first exemplary embodiment. The camera 100 is an information processing apparatus that performs user authentication. The camera 100 includes, as its functional components, an eye image acquisition unit 501, a feature vector calculation unit 502, a left and right eye determination unit 503, a user registration unit 504, a registration data management unit 505, and an authentication target person checking unit 506. The camera 100 further includes, as its functional components, a first authentication unit 507, a second authentication unit 508, an other person use detection unit 509, a first authentication state invalidation unit 510, an imaging unit 511, and an execution unit 520. The functional components (501 to 511 and 520) illustrated in FIG. 5 are implemented by the CPU 212 illustrated in FIGS. 2 and 3 executing programs stored in the memory unit 213 illustrated in FIGS. 2 and 3, for example.

In the present exemplary embodiment, the camera 100 authenticates, as personal authentication, whether the user is a registered person based on the user's eye E looking into the viewfinder (eyepiece lens 122). In particular, the camera 100 performs first authentication before the user captures an image using the camera 100, and further performs second authentication at imaging time (for example, during imaging). In the present exemplary embodiment, the camera 100 stores the authentication results along with the captured image.

The eye image acquisition unit 501 is an eye image acquisition unit for acquiring an eye image that is an image of the user's eye E looking into the viewfinder (eyepiece lens 122). Specifically, the eye image acquisition unit 501 acquires the eye image (eye image signal; electrical signal of the eye image) from the eye image sensor 219 illustrated in FIG. 3 via the line of sight detection circuit 301.

The feature vector calculation unit 502 calculates a feature vector, which is feature information for use in authenticating the user (authentication target user), from the eye image acquired by the eye image acquisition unit 501. Here, the feature vector is calculated, for example, using a neural network as a feature extractor. For example, the present exemplary embodiment uses a convolutional neural network (CNN), which is a type of neural network. This CNN extracts abstracted information from an input image by repeating processing including convolution, activation, and pooling processes on the input image. Here, the unit of processing consisting of convolution, activation, and pooling processes is often referred to as a layer. Various conventional techniques have been known for the activation process to be used here. For example, a technique called rectified linear unit (ReLU) may be used. Various conventional techniques have also been known for the pooling process. For example, a technique called maximum pooling may be used. As a CNN structure, a residual network (ResNet) may be used, for example.

A neural network known as VisionTransformer (ViT) may also be used. The configuration of the neural network is not limited to the foregoing. The feature vector calculation unit 502 may store information such as the structure and weights of the neural network in the memory unit 213. The weights of the neural network for the feature vector calculation unit 502 to use are ones acquired by training in advance. For example, various people's eye images for training are acquired in advance, and the neural network is trained using a method such as ArcFace. While the example of using a neural network is described as a method for eye image-based personal authentication, conventional methods known as iris authentication (for example, the method discussed in Japanese Patent No. 3307936) may be used. The method for personal authentication on the user is not limited to the foregoing.

The left and right eye determination unit 503 is a determination unit that determines whether the eye image acquired by the eye image acquisition unit 501 is that of the user's (authentication target user's) right eye or left eye. For example, in the present exemplary embodiment, the left and right eye determination unit 503 determines whether the eye image acquired by the eye image acquisition unit 501 is that of the right eye or the left eye based on a discrepancy between the user's (authentication target user's) line of sight estimated from the acquired eye image and the actual line of sight of the user (authentication target user).

The user registration unit 504 generates data to be registered in the registration data management unit 505.

The registration data management unit 505 is a management unit that manages authentication registration information about users to permit use of the camera 100 corresponding to the information processing apparatus. Specifically, the registration data management unit 505 stores the feature vectors of the registered users' eye images and the names of the registered users in the memory unit 213 in association with each other.

In the present exemplary embodiment, the registration data management unit 505 stores authentication registration information for use in the first authentication and authentication registration information for use in the second authentication of the same user in the memory unit 213 in association with each other.

FIGS. 5B to 5E are charts illustrating the first exemplary embodiment, illustrating examples of various tables managed by the registration data management unit 505 illustrated in FIG. 5A. Specifically, FIG. 5B illustrates a registered person information table 530, which is a table associating a personal identifier (ID) with the registered user's name. FIG. 5C illustrates a first authentication registered right eye feature vector table 540, which is a table associating the personal ID with a first authentication registered right eye feature vector to be used by the first authentication unit 507.

FIG. 5D illustrates a first authentication registered left eye feature vector table 550, which is a table associating the personal ID with a first authentication registered left eye feature vector to be used by the first authentication unit 507. FIG. 5E illustrates a second authentication registered feature vector table 560, which is a table associating the personal ID with second authentication registered feature vectors to be used by the second authentication unit 508.

The various tables 530 to 560 illustrated in FIGS. 5B to 5E link the pieces of information about the same registered user by using the personal ID.

FIG. 5F is a diagram illustrating the first exemplary embodiment, illustrating an example of an authentication state table 570 managed by the authentication state management unit 521 illustrated in FIG. 5A. Like the various tables 530 to 560 illustrated in FIG. 5B to 5E, the authentication state table 570 illustrated in this FIG. 5F also links the information about the same registered user by using the personal ID.

Now, return to the description of FIG. 5A.

The authentication target person checking unit 506 checks whether two eye images acquired by the eye image acquisition unit 501 are ones acquired from the same person (authentication target user).

The first authentication unit 507 authenticates the authentication target user by using feature vectors that are feature information based on the eye images acquired from the right and left eyes of the authentication target user and are calculated by the feature vector calculation unit 502, and the authentication registration information managed by the registration data management unit 505. In the present exemplary embodiment, the feature vectors that are the feature information based on the eye images acquired from the right and left eyes of the registration target user and are calculated by the feature vector calculation unit 502 correspond to a plurality of pieces of authentication target information that is a plurality of pieces of biological information acquired from a plurality of parts of the authentication target user. The authentication (first authentication) of the authentication target user by the first authentication unit 507 is performed before the authentication target user captures an image using the camera 100 (at non-imaging time). In the present exemplary embodiment, the first authentication unit 507 may be configured to determine that the first authentication is successful if authentication using at least one of the plurality of pieces of authentication target information succeeds.

The second authentication unit 508 authenticates the authentication target user by using authentication target information acquired from one of a plurality of parts (left and right eyes) of the authentication target user and the authentication management information managed by the registration data management unit 505. The authentication (second authentication) of the authentication target user by the second authentication unit 508 is performed while the authentication target user is capturing an image using the camera 100 (at imaging time). For example, the second authentication by the second authentication unit 508 is performed after the first authentication by the first authentication unit 507 succeeds.

In the present exemplary embodiment, the first and second authentication units 507 and 508 constitute an “authentication unit” that authenticates the authentication target user. Here, the first authentication unit 507 desirably uses authentication settings with a low false acceptance rate. By contrast, the second authentication unit 508 desirably uses authentication settings with a low false rejection rate. For example, such authentication settings can be implemented by the first and second authentication units 507 and 508 using the same authentication method but different similarity thresholds. Specifically, in such a case, a high similarity threshold is set for the first authentication unit 507, and a low similarity threshold is set for the second authentication unit 508. This can lower the false acceptance rate of the first authentication unit 507 and lower the false rejection rate of the second authentication unit 508. In such a manner, when both the false acceptance rate and the false rejection rate are difficult to simultaneously reduce at imaging time alone, two-factor authentication can be performed to achieve such a reduction.

The other person use detection unit 509 detects the execution of imaging by a person (another person) different from the one authenticated by the first authentication unit 507. The other person use detection unit 509 detects whether the person is the same or another one based on the pattern of authentication failures made by the second authentication unit 508. Specifically, the other person use detection unit 509 determines that the person is another one if the authentication by the second authentication unit 508 fails a predetermined number of times or more in succession. Alternatively, the other person use detection unit 509 determines that the person is another one if an authentication score of the second authentication unit 508 is significantly low. The method for determining whether the person is another one is not limited to the foregoing.

If the first authentication by the first authentication unit 507 is successful, the first authentication state invalidation unit 510 determines whether to invalidate the authentication state. There are several invalidation determination methods.

A first invalidation determination method is based on the time elapsed since the success of the first authentication.

For example, when the time elapsed since the success of the first authentication exceeds an expiration time determined in advance, the first authentication state is invalidated. If the second authentication succeeds while the first authentication is valid, the expiration time is extended. On the other hand, if the second authentication fails, the expiration time is shortened. The invalidation determination method based on the elapsed time is not limited to the foregoing.

A second invalidation determination method is based on a change in the state of the power supply of the camera 100. For example, the first authentication state is invalidated when the camera 100 is powered off or when the camera 100 enters a sleep mode. Note that the processing for invalidating the first authentication state is unable to be executed once the camera 100 is powered off due to dead battery. The first authentication state may therefore be invalidated when the power is turned on instead of when the power is turned off. The same applies to the sleep mode. The first authentication state may be invalidated upon resumption from the sleep mode. The invalidation determination method based on a change in the state of the power supply of the camera 100 is not limited to the foregoing.

A third invalidation determination method is based on a distance from or connection state with a device carried by the user. Examples of the device include a smartphone. For example, a smartphone owned by the user and the camera 100 are connected by Bluetooth®, and the first authentication state is invalidated when the connection is disconnected. Alternatively, an approximate distance may be estimated from the connection state, and the first authentication state may be invalidated when the distance can be determined to be greater than a predetermined level. This can prevent the camera 100 from being used by another person when the user leaves the camera 100. Other examples of the device than the smartphone may include a radio frequency identification (RFID) tag. The invalidation determination method based on the distance from or connection state with the device carried by the user is not limited to the foregoing. A fourth invalidation determination method is based on input of the user's explicit operation for invalidation. For example, an operation menu item “invalidate the first authentication” is prepared on a menu, and the user selects and runs the item using the operation members 123 to 125. Alternatively, a switch button such as an invalidation button is provided on the camera 100, and the user presses the switch button. The first authentication state is invalidated when such operations are accepted. The invalidation determination method based on the input of the user's explicit operation for invalidation is not limited to the foregoing.

A fifth invalidation determination method is based on the detection result of the other person use detection unit 509. Specifically, the first authentication state is invalidated when another person's use is detected by the other person use detection unit 509.

The first to fifth invalidation determination methods described above can be used in combination to reduce the possibility of erroneous false acceptance by the second authentication. Specifically, the fourth invalidation determination method enables the user to intentionally prevent another person's use. In addition, the first to third invalidation determination methods can invalidate the first authentication state to preemptively prevent another person's use in situations where the possibility of use by the user authenticated by the first authentication is low. Moreover, the fifth invalidation determination method can prevent another person's use by invalidating the first authentication state when another person's use is suspected.

The imaging unit 511 receives the user's depression signal of the release button 121, and stores the image (object image) captured by the image sensor 211 into the memory unit 213.

The execution unit 520 executes predetermined processing based on the authentication states of the first authentication and the second authentication.

As illustrated in FIG. 5A, the execution unit 520 includes the authentication state management unit 521, an authentication state storage unit 522, and an authentication state display unit 523.

The authentication state management unit 521 performs management processing on the authentication states of the first authentication by the first authentication unit 507 and the second authentication by the second authentication unit 508 as predetermined processing. In addition, the authentication state management unit 521 performs management processing about the presence or absence of another person's use. For example, the authentication state management unit 521 retains the authentication state table 570 illustrated in FIG. 5E in the memory unit 213 and executes the management processing.

The authentication state table 570 illustrated in FIG. 5F will be described.

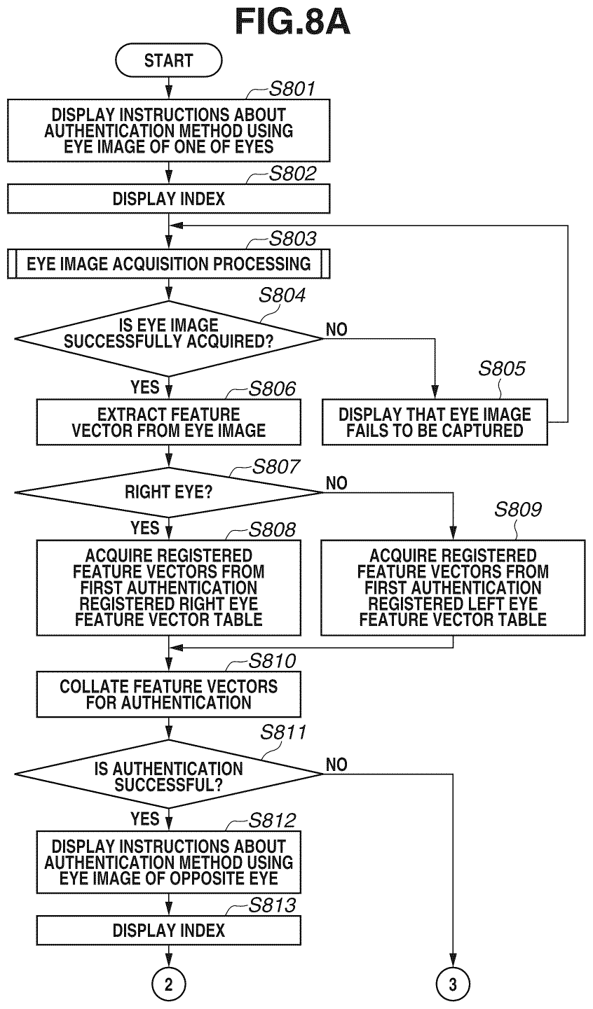

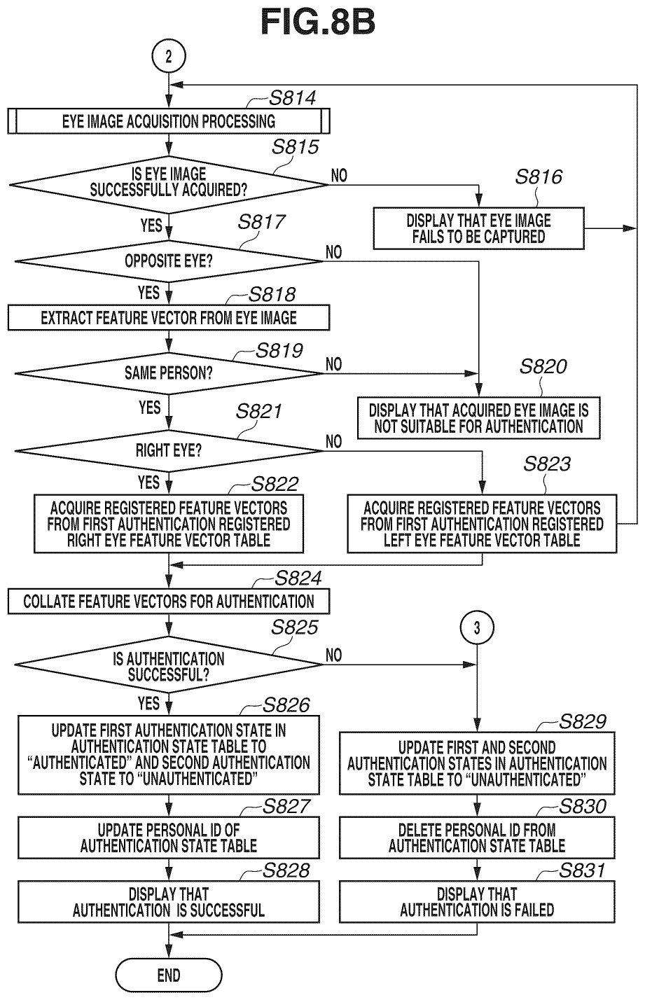

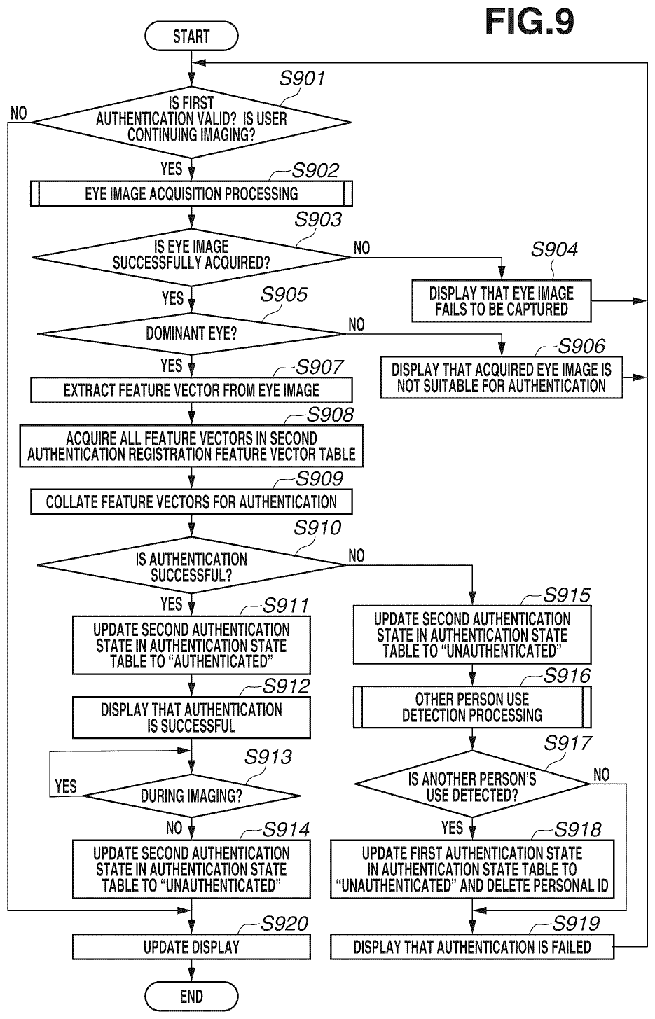

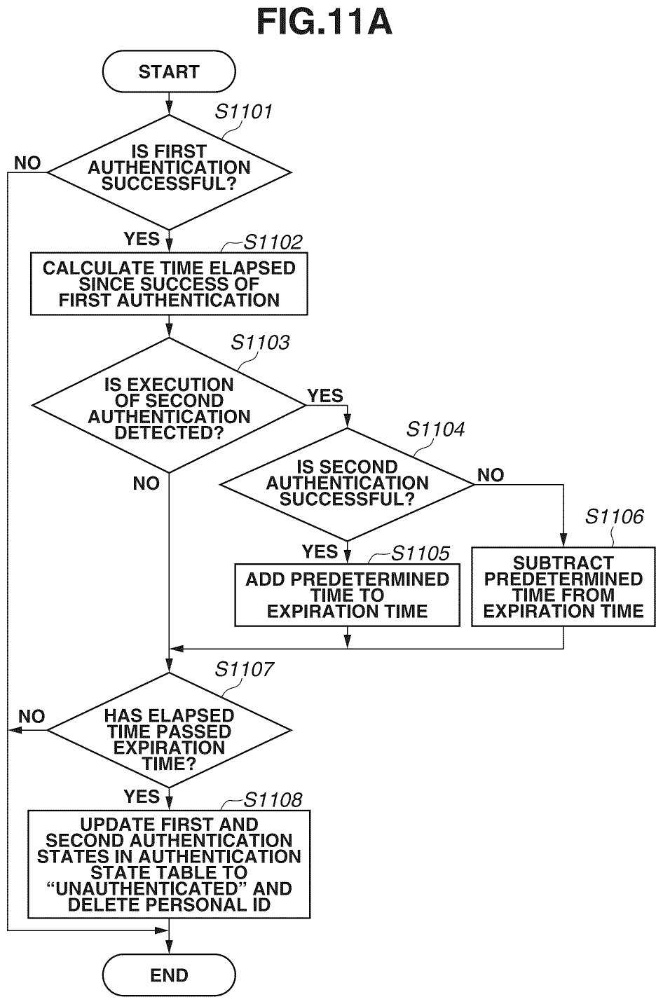

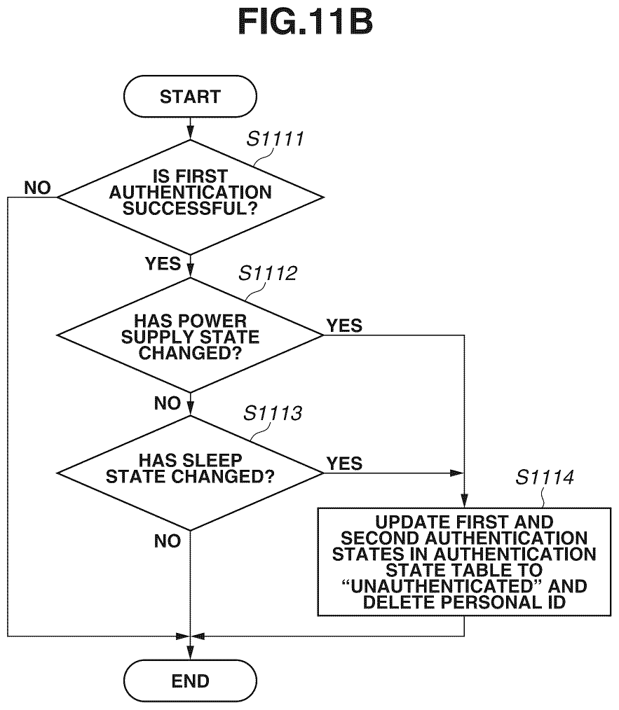

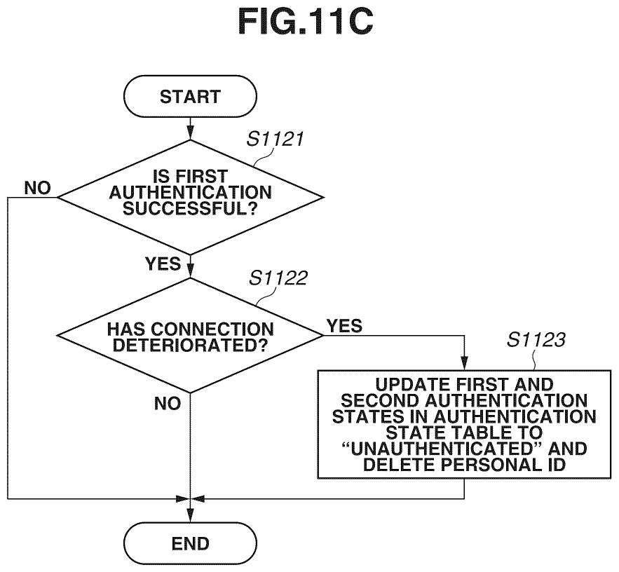

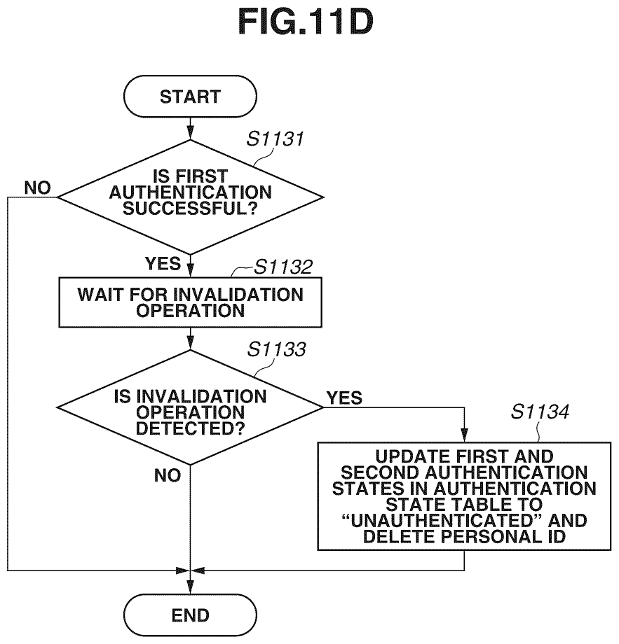

“First authentication state” in the authentication state table 570 indicates whether the first authentication by the first authentication unit 507 is in effect, and takes one of two values “authenticated” and “unauthenticated”. A personal ID indicates the ID of the person identified by the first authentication. If the first authentication state is “unauthenticated”, the personal ID has a value indicating empty, such as null. “Second authentication state” in the authentication state table 570 indicates whether the second authentication by the second authentication unit 508 is in effect, and takes one of two values “authenticated” and “unauthenticated”. “Use by another person” in the authentication state table 570 indicates whether another person's use is detected by the other person use detection unit 509, and takes one of two values “yes” and “no”. Specific processing for updating the authentication state table 570 will be described below in conjunction with a description of first authentication processing (FIGS. 8A and 8B), second authentication processing (FIG. 9), and first authentication invalidation processing (FIGS. 11A to 11D). The method by which the memory unit 213 retains the authentication state table 570 is not limited to a table structure. For example, a key-value structure may be used.

Now, return to the description of FIG. 5A again.

The authentication state storage unit 522 performs, as predetermined processing, storage processing for storing the authentication states of the first authentication and the second authentication managed by the authentication state management unit 521 and the presence or absence of another person's use as metadata in association with the image acquired by the imaging unit 511. Examples of the processing for storing image metadata include a method known as Coalition for Content Provenance and Authenticity (C2PA). This C2PA is a method that adds metadata indicating the content of editing performed on an image to the image for the purpose of authenticating the source, circumstances, and provenance of the image. The authentication state storage unit 522 may thus store the authentication states according to C2PA. In the present exemplary embodiment, the metadata may be stored by other methods. The image file and a metadata file may be separately stored. The metadata may be retained in a database.

The authentication state display unit 523 performs, as predetermined processing, display processing for displaying the authentication states of the first and second authentications managed by the authentication state management unit 521 on the camera 100. For example, if the first authentication state is “authenticated”, the authentication state display unit 523 displays “first authentication: authenticated” on the display device 214 or the touchscreen (operation member 123). The camera 100 may include a light-emitting diode (LED) lamp (not illustrated), and the authentication state display unit 523 may light up the LED lamp when the first authentication state is “authenticated”.

In the present exemplary embodiment, the execution unit 520 can be configured to change the content of the predetermined processing by the authentication state management unit 521, the authentication state storage unit 522, and the authentication state display unit 523 based on the authentication results of the first authentication and the second authentication.

### [Registration Processing]

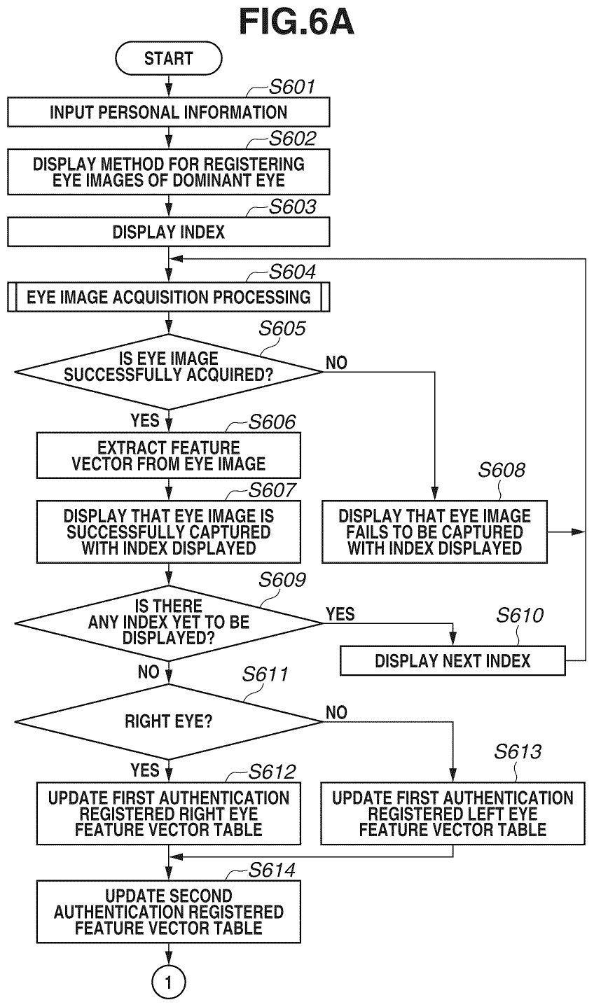

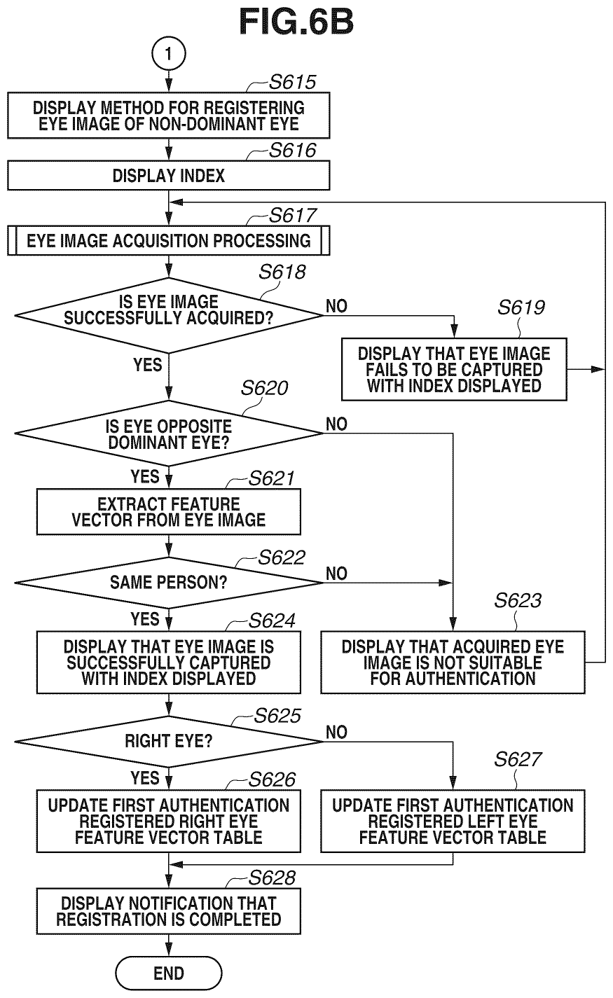

FIGS. 6A and 6B are flowcharts illustrating an example of a detailed processing procedure for registration processing in a method for controlling the camera 100 corresponding to the information processing apparatus according to the first exemplary embodiment. The processing of the flowcharts illustrated in FIGS. 6A and 6B is mainly performed by the user registration unit 504 on the CPU 212. The processing of the flowcharts illustrated in FIGS. 6A and 6B is expected to be executed by the user operating the camera 100 other than at imaging time. The processing of the flowcharts illustrated in FIGS. 6A and 6B is thus executed when the user operates the camera 100 and calls the processing from a menu. For example, a not-illustrated menu screen is displayed on the touchscreen (operation member 123) of the camera 100, and the processing is executed when the user operates the menu screen using the operation members 123 to 125 and selects the menu for calling the processing.

In step S601 of FIG. 6A, the CPU 212 (user registration unit 504) accepts input of personal information about the person to be registered. In the present exemplary embodiment, the CPU 212 (user registration unit 504) accepts input of “name”. Specifically, the CPU 212 (user registration unit 504) displays a not-illustrated screen for inputting a name on the touchscreen (operation member 123), and accepts the name input by the user operating the operation members 123 to 125. When the input is completed, the user notifies the CPU 212 of the completion of the input of the name, using a completion button displayed onscreen.

In step S602 of FIG. 6A, the CPU 212 (user registration unit 504) displays a method for registering eye images of the dominant eye to the user. Specifically, the CPU 212 (user registration unit 504) displays instructions for the user on the touchscreen (operation member 123) to look into the viewfinder with their dominant eye, the eye with which the user looks into the viewfinder when capturing images. The CPU 212 (user registration unit 504) displays instructions to look at an index in the viewfinder. The CPU 212 (user registration unit 504) may also display instructions for capturing desirable eye images, like to not blink and keep the eye wide open.

In the processing of steps S603 to S614 of FIG. 6A, the indices 411 to 415 illustrated in FIG. 4C are displayed on the display device 214 in order, and feature vectors obtained from the eye images of the user in looking at the indices 411 to 415 are stored by the registration data management unit 505. The processing will be described in order.

In step S603 of FIG. 6A, the CPU 212 (user registration unit 504) displays an index on the display device 214. Specifically, the CPU 212 displays only the index 411 illustrated in FIG. 4C and not the others. Alternatively, the CPU 212 may display all the indices 411 to 415 illustrated in FIG. 4C, with only the index 411 in highlight color. Other display methods may be used as long as the user can be informed to look at the index 411.

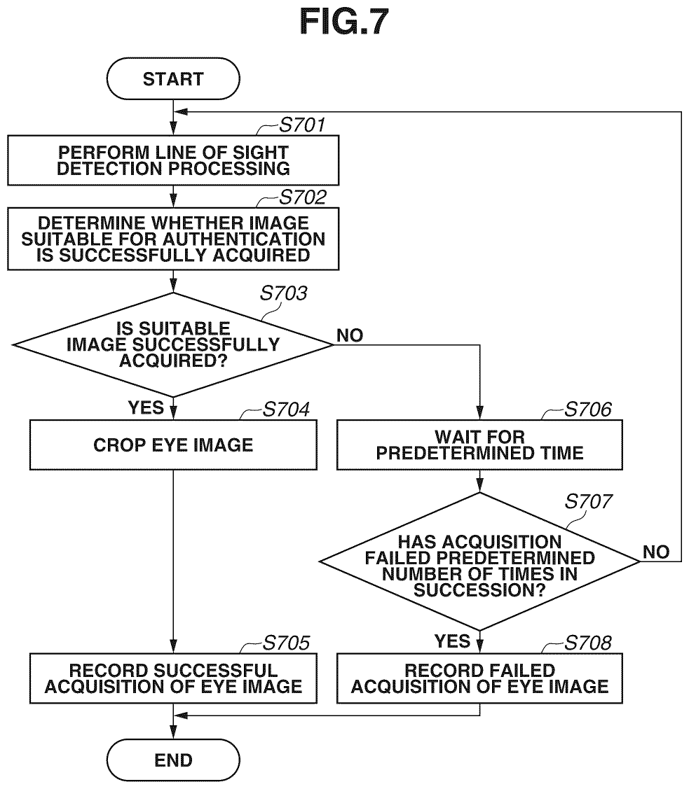

In step S604 of FIG. 6A, the eye image acquisition unit 501 acquires the eye image when the user looks into the viewfinder (eyepiece lens 122). Detailed processing of step S604 in FIG. 6A will now be described with reference to FIG. 7.

FIG. 7 is a flowchart illustrating an example of a detailed processing procedure for eye image acquisition processing in step S604 of FIG. 6A. The processing of the flowchart illustrated in this FIG. 7 is mainly performed by the eye image acquisition unit 501 on the CPU 212.

In step S701 of FIG. 7, the eye image acquisition unit 501 performs the line of sight detection processing on the user.

In step S702 of FIG. 7, the eye image acquisition unit 501 determines whether an image suitable for authentication is successfully acquired. Specifically, the eye image acquisition unit 501 determines whether an image suitable for authentication is successfully acquired based on whether the line of sight detection processing of step S701 is successful. For example, in the line of sight detection processing of step S701, the eye image acquisition unit 501 acquires an eye image (eye image signal; electrical signal of an eye image) from the eye image sensor 219 via the line of sight detection circuit 301. The eye image acquisition unit 501 then determines the coordinates of the corneal reflection images of the light sources 216a and 216b and the pupil center observed on the eye image. The eye image acquisition unit 501 then determines the coordinates of the user's gaze on the display device 214 from the determined coordinates. For such a reason, if the coordinates of the pupil center are unable to be detected, the eye image acquisition unit 501 determines that the line of sight detection processing is failed. If the coordinates are not obtained in step S603 of FIG. 6A that is the processing for obtaining the coordinates of the pupil center, the eye image acquisition unit 501 may thus determine that an image suitable for authentication is not successfully acquired.

In step S703 of FIG. 7, the eye image acquisition unit 501 determines whether an image suitable for authentication is successfully acquired based on the determination result of step S702.

If, in step S703 of FIG. 7, the eye image acquisition unit 501 determines that an image (eye image) suitable for authentication is successfully acquired (YES in step S703), the processing proceeds to step S704.

In step S704 of FIG. 7, the eye image acquisition unit 501 acquires an eye image by cropping. Specifically, the eye image acquisition unit 501 initially obtains the eye image acquired in step S701. The eye image acquisition unit 501 crops the eye image to a certain size so that a pupil center image c′ comes to the image center, using the coordinates of the pupil eye image c′ obtained in step S701. The eye image acquisition unit 501 further generates and acquires a resized image by resizing the cropped image to the input size of the neural network of the feature vector calculation unit 502.

In step S705 of FIG. 7, the eye image acquisition unit 501 records the successful acquisition of the eye image, using a flag.

If, in step S703 of FIG. 7, the eye image acquisition unit 501 determines that an eye image suitable for authentication is not successfully acquired (fails to be acquired) (NO in step S703), the processing proceeds to step S706.

In step S706 of FIG. 7, the eye image acquisition unit 501 performs processing for waiting for a predetermined time. The processing of this step S706 is performed in expectation of the eye image changing and succeeding in the line of sight detection.

In step S707 of FIG. 7, the eye image acquisition unit 501 determines whether the acquisition of an eye image suitable for authentication has failed a predetermined number of times in succession. If, in step S707 of FIG. 7, the eye image acquisition unit 501 determines that the acquisition of an eye image suitable for acquisition has not failed the predetermined number of times in succession (NO in step S707), the processing returns to step S701. The processing of steps S701 and onward is then repeated.

If, in step S707 of FIG. 7, the eye image acquisition unit 501 determines that the acquisition of an eye image suitable for authentication has failed the predetermined number of times in succession (YES in step S707), the processing proceeds to step S708.

In step S708 of FIG. 7, the eye image acquisition unit 501 records the failed acquisition of the eye image, using the flag.

When the processing of step S705 in FIG. 7 is completed, or the processing of step S708 in FIG. 7 is completed, the processing of flowchart of FIG. 7 ends. With the processing of the flowchart of FIG. 7 completed, the eye image acquisition processing in step S604 of FIG. 6A ends.

Return to the description of FIG. 6A.

With the processing of step S604 in FIG. 6A completed, the processing proceeds to step S605.

In step S605 of FIG. 6A, the eye image acquisition unit 501 determines whether an eye image is successfully acquired. Specifically, the eye image acquisition unit 501 determines whether an eye image is successfully acquired, based on the flag recorded in step S705 or S708 of FIG. 7.

If, in step S605 of FIG. 6A, the eye image acquisition unit 501 determines that an eye image is successfully acquired (YES in step S605), the processing proceeds to step S606.

In step S606 of FIG. 6A, the feature vector calculation unit 502 extracts a feature vector from the eye image as authentication registration information for authenticating the user. Specifically, the feature vector calculation unit 502 extracts the feature vector from the eye image acquired in step S604 of FIG. 6A.

In step S607 of FIG. 6A, the CPU 212 (user registration unit 504) displays, on the display device 214, that an eye image is successfully captured with the index displayed on the display device 214. For example, the CPU 212 (user registration unit 504) may display a message that “an eye image has been successfully captured” on the display device 214, or display an icon indicating the success.

If, in step S605 of FIG. 6A, the eye image acquisition unit 501 determines that an eye image is not successfully acquired (fails to be acquired) (NO in step S605), the processing proceeds to step S608.

In step S608 of FIG. 6A, the CPU 212 (user registration unit 504) displays, on the display device 214, that an eye image fails to be captured with the index displayed on the display device 214. For example, the CPU 212 (user registration unit 504) may display a message that “an eye image has failed to be captured” on the display device 214, or display an icon indicating the failure. With the processing of step S608 completed, the processing returns to step S604.

With the processing of step S607 in FIG. 6A completed, the processing proceeds to step S609.

In step S609 of FIG. 6A, the CPU 212 (user registration unit 504) determines whether there is any index yet to be displayed. The CPU 212 (user registration unit 504) checks whether all the indices 411 to 415 illustrated in FIG. 4C have been displayed, and determines whether there is any index yet to be displayed.

If, in step S609 of FIG. 6A, the CPU 212 (user registration unit 504) determines that there is an index yet to be displayed (YES in step S609), the processing proceeds to step S610.

In step S610 of FIG. 6A, the CPU 212 (user registration unit 504) displays the next index among those not displayed yet on the display device 214. For example, if the index 411 illustrated in FIG. 4C has been displayed, the CPU 212 (user registration unit 504) displays the index 412 on the display device 214 as the next index. In such a manner, the CPU 212 selects and displays the indices 411 to 415 on the display device 214 in order of the index numbers. With the processing of step S610 completed, the processing returns to step S604.

If, in step S609 of FIG. 6A, the CPU 212 (user registration unit 504) determines that there is no index yet to be displayed (NO in step S609), the processing proceeds to step S611.

In step S611 of FIG. 6A, the CPU 212 (user registration unit 504) determines whether the eye images acquired in step S604 are ones acquired from the right eye.

If, in step S611 of FIG. 6A, the CPU 212 (user registration unit 504) determines whether the eye images acquired in step S604 are ones acquired from the right eye (YES in step S611), the processing proceeds to step S612.

In step S612 of FIG. 6A, the CPU 212 (user registration unit 504) stores the acquired information into the first authentication registered right eye feature vector table 540 illustrated in FIG. 5C for update.

If, in step S611 of FIG. 6A, the CPU 212 (user registration unit 504) determines that the eye images acquired in step S604 are not ones acquired from the right eye (are ones acquired from the left eye) (NO in step S611), the processing proceeds to step S613.

In step S613 of FIG. 6A, the CPU 212 (user registration unit 504) stores the acquired information into the first authentication registered left eye feature vector table 550 illustrated in FIG. 5D for update.

When the processing of step S612 in FIG. 6A is completed, or the processing of step S613 in FIG. 6A is completed, the processing proceeds to step S614.

In step S614 of FIG. 6A, the CPU 212 (user registration unit 504) stores the acquired information into the second authentication registered feature vector table 560 illustrated in FIG. 5E for update.

In steps S612 to S614 of FIG. 6A, the acquired information is stored in the registered person information table 530, the first registration registered right eye feature vector table 540, the first authentication registered left eye feature vector table 550, and the second authentication registered feature vector table 560. Specifically, since the personal IDs in the four tables 530 to 560 illustrated in FIGS. 5B to 5E are IDs intended to relate the tables 530 to 560 to each other, the same ID value is used in the four tables 530 to 560. The name that is the personal information acquired in step S601 of FIG. 6A is added to the registered person information table 530 illustrated in FIG. 5B. The feature vectors acquired in step S606 of FIG. 6A are divided and stored in the first authentication registered right eye feature vector table 540 illustrated in FIG. 5C, the first authentication registered left eye feature vector table 550 illustrated in FIG. 5D, and the second authentication registered feature vector table 560 illustrated in FIG. 5E. The feature vectors are divided in the following manner.

In the first authentication processing (to be described below with reference to FIGS. 8A and 8B), an index is displayed on the display device 214 and authentication is performed using the eye images of both eyes when the user looks at the index. For that purpose, only the feature vector with the index to be displayed in that process is stored in the first authentication registered feature right or left eye vector table 540 or 550 as a registered feature vector for use in the first authentication. In the present exemplary embodiment, if the feature vector acquired with the index 411 displayed is acquired from the right eye, the feature vector is registered in the first authentication registered right eye feature vector table 540 in step S612 of FIG. 6A. If the feature vector acquired with the index 411 displayed is acquired from the left eye, the feature vector is registered in the first authentication registered left eye feature vector table 550 in step S613 of FIG. 6A.

By contrast, in the second authentication processing (to be described below with reference to FIG. 9), the display device 214 displays an image being captured by the image sensor 211, without any index. Where the user gazes at on the display device 214 is therefore unknown. In the present exemplary embodiment, all the feature vectors acquired with the indices 411 to 415 displayed are therefore registered in step S614 of FIG. 6A.

With the processing of step S614 in FIG. 6A completed, the processing proceeds to step S615 of FIG. 6B.

In step S615 of FIG. 6B, the CPU 212 (user registration unit 504) displays a method for registering an eye image of the non-dominant eye to the user. Specifically, the CPU 212 (user registration unit 5049 displays instructions for the user on the touchscreen (operation member 123) to look into the viewfinder with the eye (non-dominant eye) opposite their dominant eye with which the user looks into the viewfinder when capturing images. The CPU 212 (user registration unit 504) displays instructions to look at the index in the viewfinder. In addition, the CPU 212 (user registration unit 504) may display instructions for capturing a desirable eye image, like to not blink and keep the eye wide open.

In step S616 of FIG. 6B, the CPU 212 (user registration unit 504) displays the index on the display device 214. The specific processing of this step S616 in FIG. 6B is similar to the processing of step S603 in FIG. 6A. A description thereof will thus be omitted.

In step S617 of FIG. 6B, the eye image acquisition unit 501 acquires an eye image when the user looks into the viewfinder (eyepiece lens 122). The specific processing of this step S617 in FIG. 6B is similar to the processing of step S604 in FIG. 6A (the processing of the flowchart illustrated in FIG. 7). A description thereof will thus be omitted.

In step S618 of FIG. 6B, the eye image acquisition unit 501 determines whether an eye image is successfully acquired. Specifically, the eye image acquisition unit 501 determines whether an eye image is successfully acquired, based on the flag recorded in step S705 or S708 of FIG. 7.

If, in step S618 of FIG. 6B, the eye image acquisition unit 501 determines that an eye image is not successfully acquired (fails to be acquired) (NO in step S618), the processing proceeds to step S619.

In step S619 of FIG. 6B, the CPU 212 (user registration unit 504) displays, on the display device 214, that an eye image fails to be captured with the index displayed on the display device 214. For example, the CPU 212 (user registration unit 504) may display a message that “an eye image has failed to be captured” on the display device 214, or display an icon indicating the failure. With the processing of step S619 completed, the processing returns to step S617.

If, in step S618 of FIG. 6B, the eye image acquisition unit 501 determines that an eye image is successfully acquired (YES in step S618), the processing proceeds to step S620.

In step S620 of FIG. 6B, the CPU 212 (user registration unit 504) determines whether the eye in the eye image acquired in step S617 is opposite the dominant eye in the eye images acquired in step S604. A specific determination method of step S620 is similar to that of step S611.

If, in step S620 of FIG. 6B, the CPU 212 (user registration unit 504) determines that the eye in the eye image acquired in step S617 is opposite the dominant eye in the eye images acquired in step S604 (YES in step S620), the processing proceeds to step S621.

In step S621 of FIG. 6B, the feature vector calculation unit 502 extracts a feature vector from the eye image as authentication registration information for authenticating the user. Specifically, the feature vector calculation unit 502 extracts the feature vector from the eye image acquired in step S617 of FIG. 6B.

In step S622 of FIG. 6B, the eye image acquisition unit 501 determines whether the person looking into the viewfinder in step S604 and the person looking into the viewfinder in step S617 are the same. A specific determination method of step S622 includes, for example, determining a cosine (cos) similarity between the feature vector extracted in step S606 and the feature vector extracted in step S621, and if the determined cos similarity exceeds a predetermined threshold, determining that the persons are the same.

If, in step S622 of FIG. 6B, the eye image acquisition unit 501 determines that the person looking into the viewfinder in step S604 and the person looking into the viewfinder in step S617 are not the same (NO in step S622), the processing proceeds to step S623. If, in step S620 of FIG. 6B, the CPU 212 (user registration unit 504) determines that the eye in the eye image acquired in step S617 is not opposite the dominant eye in the eye images acquired in step S604 (NO in step S620), the processing proceeds to step S623.

In step S623 of FIG. 6B, the CPU 212 (user registration unit 504) displays, on the display device 214, that the acquired eye image is not suitable for authentication. For example, the CPU 212 (user registration unit 504) may display a message that “the eye image is not suitable for authentication” on the display device 214. With the processing of step S623 completed, the processing returns to step S617.

If, in step S622 of FIG. 6B, the eye image acquisition unit 501 determines that the person looking into the viewfinder in step S604 and the person looking into the viewfinder in step S617 are the same (YES in step S622), the processing proceeds to step S624.

In step S624 of FIG. 6B, the CPU 212 (user registration unit 504) displays, on the display device 214, that an eye image is successfully captured with the index displayed on the display device 214. For example, the CPU 212 (user registration unit 504) may display a message that “an eye image has been successfully captured” on the display device 214, or display an icon indicating the success.

In step S625 of FIG. 6B, the CPU 212 (user registration unit 504) determines whether the eye image acquired in step S617 is one acquired from the right eye.

If, in step S625 of FIG. 6B, the CPU 212 (user registration unit 504) determines that the eye image acquired in step S617 is one acquired from the right eye (YES in step S617), the processing proceeds to step S626.

In step S626 of FIG. 6B, the CPU 212 (user registration unit 504) stores the acquired information into the first authentication registered right eye feature vector table 540 illustrated in FIG. 5C for update.

If, in step S625 of FIG. 6B, the CPU 212 (user registration unit 504) determines that the eye image acquired in step S617 is not one acquired from the right eye (is one acquired from the left eye) (NO in step S625), the processing proceeds to step S627.

In step S627 of FIG. 6B, the CPU 212 (user registration unit 504) stores the acquired information into the first authentication registered left eye feature vector table 550 illustrated in FIG. 5D for update.

When the processing of step S626 in FIG. 6B is completed, or the processing of step S627 in FIG. 6B is completed, the processing proceeds to step S628.

In step S628 of FIG. 6B, the CPU 212 (user registration unit 504) provides display on the touchscreen (operation unit 123) of the display device 214 to inform the user that the registration is completed.

With the processing of step S628 in FIG. 6B completed, the processing of the flowcharts of FIGS. 6A and 6B ends.

The registration processing illustrated in FIGS. 6A and 6B falls into an infinite loop unless eye images are successfully acquired in steps S605 and S618. The registration processing is therefore desirably configured to be discontinued if a failure is observed a predetermined number of times.

### [First Authentication Processing]

FIGS. 8A and 8B are flowcharts illustrating an example of a detailed processing procedure for the first authentication processing in the method for controlling the camera 100 corresponding to the information processing apparatus according to the first exemplary embodiment. The processing of the flowcharts illustrated in FIGS. 8A and 8B is mainly performed by the first authentication unit 507 on the CPU 212. The first authentication processing illustrated in FIGS. 8A and 8B is expected to be executed by the user operating the camera 100 other than at imaging time. The processing of the flowcharts illustrated in FIGS. 8A and 8B is thus executed when the user operates the camera 100 and calls this processing from a menu. For example, a not-illustrated menu screen is displayed on the touchscreen (operation member 123) of the camera 100, and this processing is executed when the user operates the menu screen using the operation members 123 to 125 and selects the menu for calling the processing.

In step S801 of FIG. 8A, the CPU 212 (first authentication unit 507) issues instructions for the user about an authentication method using an eye image of one of the eyes. Specifically, the CPU 212 (first authentication unit 507) displays instructions for the user on the touchscreen (operation member 123) to look into the viewfinder with one of the left and right eyes and look at the index displayed on the display device 214. In addition, the CPU 212 (user registration unit 504) may display instructions for capturing a desirable eye image, like to not blink, keep the eye wide open, and firmly hold the camera 100.

In step S802 of FIG. 8A, the CPU 212 (first authentication unit 507) displays the index on the display device 214. Specifically, the CPU 212 displays only the index 411 as illustrated in FIG. 4D. The reason is that the feature vectors in looking at the index 411 are registered in the first authentication registered right and left eye feature vector tables 540 and 550 illustrated in FIGS. 5C and 5D in the foregoing registration processing. Eye images with similar lines of sight can thereby be obtained during registration and during authentication. This facilitates collation of the eye images.

In step S803 of FIG. 8A, the eye image acquisition unit 501 acquires an eye image when the user looks into the viewfinder (eyepiece lens 122). The specific processing of step S803 in FIG. 8A is similar to the processing of step S604 in FIG. 6A (the processing of the flowchart illustrated in FIG. 7A). A description thereof will thus be omitted.

In step S804 of FIG. 8A, the eye image acquisition unit 501 determines whether an eye image is successfully acquired. Specifically, the eye image acquisition unit 501 determines whether an eye image is successfully acquired, based on the flag recorded in step S705 or S708 of FIG. 7.

If, in step S804 of FIG. 8A, the eye image acquisition unit 501 determine that an eye image is not successfully acquired (fails to be acquired) (NO in step S804), the processing proceeds to step S805.

In step S805 of FIG. 8A, the CPU 212 (first authentication unit 507) displays, on the display device 214, that an eye image fails to be acquired with the index displayed on the display device 214. For example, the CPU 212 (first authentication unit 507) may display a message that “an eye image has failed to be captured” on the display device 214, or display an icon indicating the failure. With the processing of step S805 completed, the processing returns to step S803.

If, in step S804 of FIG. 8A, the eye image acquisition unit 501 determines that an eye image is successfully acquired (YES in step S804), the processing proceeds to step S806.

In step S806 of FIG. 8A, the feature vector calculation unit 502 extracts a feature vector from the eye image as authentication target information for authenticating the user. Specifically, the feature vector calculation unit 502 extracts the feature vector from the eye image acquired in step S803 of FIG. 8A.

In step S807 of FIG. 8A, the CPU 212 (first authentication unit 507) determines whether the eye image acquired in step S803 is one acquired from the right eye.

If, in step S807 of FIG. 8A, the CPU 212 (first authentication unit 507) determines that the eye image acquired in step S803 is one acquired from the right eye (YES in step S807), the processing proceeds to step S808.

In step S808 of FIG. 8A, the CPU 212 (first authentication unit 507) acquires registered feature vectors for use in the first authentication from the first authentication registered right eye feature vector table 540 illustrated in FIG. 5C via the registration data management unit 505. Specifically, the CPU 212 (first authentication unit 507) acquires all the feature vectors in the first authentication registered right eye feature vector table 540 illustrated in FIG. 5C.

If, in step S807 of FIG. 8A, the CPU 212 (first authentication unit 507) determines that the eye image acquired in step S803 is not one acquired from the right eye (is an eye image acquired from the left eye) (NO in step S807), the processing proceeds to step S809.

In step S809 of FIG. 8A, the CPU 212 (first authentication unit 507) acquires registered feature vectors for use in the first authentication from the first authentication registered left eye feature vector table 550 illustrated in FIG. 5D via the registration data management unit 505. Specifically, the CPU 212 (first authentication unit 507) acquires all the feature vectors in the first authentication registered left eye feature vector table 550 illustrated in FIG. 5D.

When the processing of step S808 in FIG. 8A is completed, or the processing of step S809 in FIG. 8A is completed, the processing proceeds to step S810.

In step S810 of FIG. 8A, the CPU 212 (first authentication unit 507) collates the feature vector that is the authentication target information acquired in step S806 with each of the registered feature vectors that are the authentication registration information acquired in step S808 or S809 for first authentication. Specifically, in the processing of this step S810, the CPU 212 (first authentication unit 507) determines a cos similarity between the two feature vectors and performs the first authentication based on whether the determined cos similarity exceeds a predetermined threshold. More specifically, if the determined cos similarity exceeds the predetermined threshold, the CPU 212 (first authentication unit 507) determines that the first threshold is successful, and identifies the personal ID of the registered feature vector.

In step S811 of FIG. 8A, the CPU 212 (first authentication unit 507) determines whether the first authentication performed in step S810 is successful.

If, in step S811 of FIG. 8A, the CPU 212 (first authentication unit 507) determines that the first authentication performed in step S810 is successful (YES in step S811), the processing proceeds to step S812.

In step S812 of FIG. 8A, the CPU 212 (first authentication unit 507) instructs the user about an authentication method using an eye image of the opposite eye from that in step S801. Specifically, the CPU 212 (first authentication unit 507) displays instructions for the user on the touchscreen (operation member 123) to look into the viewfinder with the opposite eye from that in the eye image acquired in step S803 and look at the index displayed on the display device 214. In addition, the CPU 212 (user registration unit 504) may display instructions for capturing a desirable eye image, like to not blink, keep the eye wide open, and firmly hold the camera 100.

In step S813 of FIG. 8A, the CPU 212 (first authentication unit 507) displays an index on the display device 214. The specific processing of this step S813 is similar to that of step S802.

In step S814 of FIG. 8B, the eye image acquisition unit 501 acquires an eye image when the user looks into the viewfinder (eyepiece lens 122). Like step S803 of FIG. 8A, the specific processing of this step S814 in FIG. 8B is similar to the processing of step S604 in FIG. 6A (the processing of the flowchart illustrated in FIG. 7). A description thereof will thus be omitted.

In step S815 of FIG. 8B, the eye image acquisition unit 501 determines whether an eye image is successfully acquired. Specifically, the eye image acquisition unit 501 determines whether an eye image is successfully acquired, based on the flag recorded in step S705 or S708 of FIG. 7.

If, in step S815 of FIG. 8B, the eye image acquisition unit 501 determines that an eye image is not successfully acquired (fails to be acquired) (NO in step S815), the processing proceeds to step S816.

In step S816, the CPU 212 (first authentication unit 507) displays, on the display device 214, that an eye image fails to be captured with the index displayed on the display device 214. For example, the CPU 212 (first authentication unit 507) may display a message that “an eye image has failed to be captured” on the display device 214, or display an icon indicating the failure. With the processing of step S816 completed, the processing returns to step S814.

If, in step S815 of FIG. 8B, the eye image acquisition unit 501 determines that an eye image is successfully acquired (YES in step S815), the processing proceeds to step S817.

In step S817 of FIG. 8B, the CPU 212 (first authentication unit 507) determines whether the eye in the eye image acquired in step S814 is the opposite eye from that in the eye image acquired in step S803. The specific determination method of this step S817 is similar to that of step S611.

If, in step S817 of FIG. 8B, the CPU 212 (first authentication unit 507) determines that the eye in the eye image acquired in step S814 is the opposite eye from that in the eye image acquired in step S803 (YES in step S817), the processing proceeds to step S818.

In step S818 of FIG. 8B, the feature vector calculation unit 502 extracts a feature vector from the eye image as authentication target information for authenticating the user. Specifically, the feature vector calculation unit 502 extracts the feature vector from the eye image acquired in step S814 of FIG. 8B.

In step S819 of FIG. 8B, the eye image acquisition unit 501 determines whether the person looking into the viewfinder in step S803 and the person looking into the viewfinder in step S814 are the same. The specific determination method of this step S819 is similar to that of step S622 in FIG. 6B.

If, in step S819 of FIG. 8B, the eye image acquisition unit 501 determines that the person looking into the viewfinder in step S803 and the person looking into the viewfinder in step S814 are not the same (NO in step S819), the processing proceeds to step S820. If, in step S817 of FIG. 8B, the CPU 212 (first authentication unit 507) determines that the eye in the eye image acquired in step S814 is not the opposite eye from that in the eye image acquired in step S803 (NO in step S817), the processing proceeds to step S820.

In step S820 of FIG. 8B, the CPU 212 (first authentication unit 507) displays on the display device 214 that the acquired eye image is not suitable for authentication. For example, the CPU 212 (first authentication unit 507) may display a message that “the eye image is not suitable for authentication” on the display device 214. With the processing of step S820 completed, the processing returns to step S814.

If, in step S819 of FIG. 8B, the eye image acquisition unit 501 determines that the person looking into the viewfinder in step S803 and the person looking into the viewfinder in step S814 are the same (YES in step S819), the processing proceeds to step S821.

In step S821 of FIG. 8B, the CPU 212 (first authentication unit 507) determines whether the eye image acquired in step S814 is one acquired from the right eye.

If, in step S821 of FIG. 8B, the CPU 212 (first authentication unit 507) determines that the eye image acquired in step S814 is one acquired from the right eye (YES in step S821), the processing proceeds to step S822.

In step S822 of FIG. 8B, the CPU 212 (first authentication unit 507) acquires registered feature vectors for use in the first authentication from the first authentication registered right eye feature vector table 540 illustrated in FIG. 5C via the registration data management unit 505. Specifically, the CPU 212 (first authentication unit 507) acquires all the feature vectors in the first authentication registered right eye feature vector table 540 illustrated in FIG. 5C.

If, in step S821 of FIG. 8B, the CPU 212 (first authentication unit 507) determines that the eye image acquired in step S814 is not one acquired from the right eye (is an eye image acquired from the left eye) (NO in step S821), the processing proceeds to step S823.

In step S823 of FIG. 8B, the CPU 212 (first authentication unit 507) acquires registered feature vectors for use in the first authentication from the first authentication registered left eye feature vector table 550 illustrated in FIG. 5D via the registration data management unit 505. Specifically, the CPU 212 (first authentication unit 507) acquires all the feature vectors in the first authentication registered left eye feature vector table 550 illustrated in FIG. 5D.

When the processing of step S822 in FIG. 8B is completed, or the processing of step S823 in FIG. 8B is completed, the processing proceeds to step S824.

In step S824 of FIG. 8B, the CPU 212 (first authentication unit 507) collates the feature vector that is the authentication target information acquired in step S818 with each of the registered feature vectors that are the authentication registration information acquired in step S822 or S823 for first authentication. The specific processing of this step S824 is similar to that of step S810 in FIG. 8A.

In step S825 of FIG. 8B, the CPU 212 (first authentication unit 507) determines whether the first authentication performed in step S824 is successful.

If, in step S825 of FIG. 8B, the CPU 212 (first authentication unit 507) determines that the first authentication performed in step S824 is successful (YES in step S824), the processing proceeds to step S826.

In step S826 of FIG. 8B, the authentication state management unit 521 updates the first authentication state in the authentication state table 570 illustrated in FIG. 5F to “authenticated”. The authentication state management unit 521 further updates the second authentication state in the authentication state table 570 illustrated in FIG. 5F to “unauthenticated”.

In step S827 of FIG. 8B, the authentication state management unit 521 updates the personal ID in the authentication state table 570 illustrated in FIG. 5F with the personal ID identified in step S824.

In step S828 of FIG. 8B, the CPU 212 (first authentication unit 507) provides display to inform the user that the authentication is successful on the touchscreen (operation member 123) or the display device 214 using the authentication state display unit 523.

If, in step S825 of FIG. 8B, the CPU 212 (first authentication unit 507) determines that the first authentication performed in step S824 is not successful (NO in step S824), the processing proceeds to step S829. If, in step S811 of FIG. 8A, the CPU 212 (first authentication unit 507) determines that the first authentication performed in step S810 is not successful (NO in step S811), the processing proceeds to step S829.

In step S829, the authentication state management unit 521 updates the first and second authentication states in the authentication state table 570 illustrated in FIG. 5F to “unauthenticated”.

In step S830 of FIG. 8B, the authentication state management unit 521 deletes the personal ID from the authentication state table 570 illustrated in FIG. 5F. For example, the authentication state management unit 521 may prepare a null value as a value indicating empty and overwrite the personal ID in the authentication state table 570 illustrated in FIG. 5F with the null value.

In step S831 of FIG. 8B, the CPU 212 (first authentication unit 507) provides display to inform the user that the authentication is failed on the touchscreen (operation member 123) or the display device 214 using the authentication state display unit 523.

When the processing of step S828 in FIG. 8B is completed, or the processing of step S831 in FIG. 8 is completed, the processing of the flowcharts of FIGS. 8A and 8B ends.

The first authentication processing illustrated in FIGS. 8A and 8B falls into an infinite loop unless eye images are successfully acquired in steps S804 and S815. The first authentication processing is therefore desirably configured to be discontinued if a failure is observed a predetermined number of times.

### [Second Authentication Processing]

FIG. 9 is a flowchart illustrating an example of a detailed processing procedure for the second authentication processing in the method for controlling the camera 100 corresponding to the information processing apparatus according to the first exemplary embodiment. The processing of the flowchart illustrated in this FIG. 9 is mainly performed by the second authentication unit 508 on the CPU 212. The second authentication processing illustrated in FIG. 9 is expected to be executed when the user looks into the viewfinder (eyepiece lens 122) at imaging time (during imaging). The processing of the flowchart illustrated in FIG. 9 is thus triggered by an eyepiece sensor (not illustrated) mounted on the camera 100 detecting that the user brings their eye close to the viewfinder (eyepiece lens 122). For example, the eyepiece sensor is a sensor that detects contact of the skin near the user's eye with the vicinity of the eyepiece lens 122. Alternatively, the eyepiece sensor may be a sensor that detects a distance between the eyepiece lens 122 and the user's eye. In such a case, the user can be determined to be looking into the viewfinder (eyepiece lens 122) if the distance is less than or equal to a predetermined level. Moreover, the processing of the flowchart illustrated in FIG. 9 may be triggered by detecting that the release button 121 is pressed down to the first stroke. Alternatively, the line of sight detection processing may be run in advance, and the processing of the flowchart illustrated in FIG. 9 may be triggered when the line of sight detection processing succeeds.

In step S901 of FIG. 9, the CPU 212 (second authentication unit 508) determines whether the first authentication is valid and the user is continuing imaging (during imaging). Whether the first authentication is valid is determined by checking whether the first authentication state in the authentication state table 570 illustrated in FIG. 5F is “authenticated” via the authentication state management unit 521. Whether the user is continuing imaging (during imaging) is determined by checking whether the user keeps their eye close to the viewfinder (eyepiece lens 122), using the foregoing eyepiece sensor. Whether during imaging or not may be determined based on other methods such as the pressing of the release button 121 and the line of sight detection processing.

If, in step S901 of FIG. 9, the CPU 212 (second authentication unit 508) determines that the first authentication is valid and the user is continuing imaging (during imaging) (YES in step S901), the processing proceeds to step S902.

In step S902 of FIG. 9, the eye image acquisition unit 501 acquires an eye image when the user looks into the viewfinder (eyepiece lens 122). The specific processing of this step S902 in FIG. 9 is similar to the processing of step S604 in FIG. 6A (processing of the flowchart illustrated in FIG. 7A). A description thereof will thus be omitted. If the line of sight detection processing is already running, the line of sight detection in step S701 of FIG. 7 may be skipped and the result of the line of sight detection processing already running may be used.

In step S903 of FIG. 9, the eye image acquisition unit 501 determines whether an eye image is successfully acquired. Specifically, the eye image acquisition unit 501 determines whether an eye image is successfully acquired, based on the flag recorded in step S705 or S708 of FIG. 7.

If, in step S903 of FIG. 9, the eye image acquisition unit 501 determines that an eye image is not successfully acquired (fails to be acquired) (NO in step S903), the processing proceeds to step S904.

In step S904 of FIG. 9, the CPU 212 (second authentication unit 508) displays on the display device 214 that an eye image fails to be captured. For example, the CPU 212 (second authentication unit 508) may display a message that “an eye image has failed to be captured” on the display device 214, or display an icon indicating the failure. With the processing of step S904 completed, the processing returns to step S901.

If, in step S903 of FIG. 9, the eye image acquisition unit 501 determines that an eye image is successfully acquired (YES in step S903), the processing proceeds to step S905.

In step S905 of FIG. 9, the CPU 212 (second authentication unit 508) determines whether the eye image acquired in step S902 is that of the eye registered as the dominant eye in the registration processing.

If, in step S905 of FIG. 9, the CPU 212 (second authentication unit 508) determines that the eye image acquired in step S902 is not that of the eye registered as the dominant eye in the registration processing (NO in step S905), the processing proceeds to step S906.

In step S906 of FIG. 9, the CPU 212 (second authentication unit 508) displays on the display device 214 that the acquired eye image is not suitable for authentication. For example, the CPU 212 (second authentication unit 508) may display a message that “the eye image is not suitable for authentication” on the display device 214. With the processing of step S906 completed, the processing returns to step S901.

If, in step S905 of FIG. 9, the CPU 212 (second authentication unit 508) determines that the eye image acquired in step S902 is that of the eye registered as the dominant eye in the registration processing (YES in step S905), the processing proceeds to step S907.

In step S907 of FIG. 9, the feature vector calculation unit 502 extracts a feature vector from the eye image as authentication target information for authenticating the user. Specifically, the feature vector calculation unit 502 extracts the feature vector from the eye image acquired in step S902 of FIG. 9.

In step S908 of FIG. 9, the CPU 212 (second authentication unit 508) acquires all the feature vectors in the second authentication registered feature vector table 560 illustrated in FIG. 5E via the registration data management unit 505.

In step S909 of FIG. 9, the CPU 212 (second authentication unit 508) collates the feature vector that is the authentication target information acquired in step S907 with each of the registered feature vectors that are the authentication registration information acquired in step S908 for second authentication. Specifically, the CPU 212 (second authentication unit 508) determines a cos similarity between the two feature vectors and performs the second authentication based on whether the determined cos similarity exceeds a predetermined threshold. More specifically, if the determined cos similarity exceeds the predetermined threshold, the CPU 212 (second authentication unit 508) determines that the second authentication is successful.

In step S910 of FIG. 9, the CPU 212 (second authentication unit 508) determines whether the second authentication performed in step S909 is successful.

If, in step S910 of FIG. 9, the CPU 212 (second authentication unit 508) determines that the second authentication performed in step S909 is successful (YES in step S910), the processing proceeds to step S911.

In step S911 of FIG. 9, the authentication state management unit 521 updates the second authentication state in the authentication state table 570 illustrated in FIG. 5F to “authenticated”.

In step S912 of FIG. 9, the CPU 212 (second authentication unit 508) provides display to inform the user that the authentication is successful on the display device 214 using the authentication state display unit 523.

In step S913 of FIG. 9, the CPU 212 (second authentication unit 508) determines whether the user is continuing imaging (during imaging). The method for determining whether the user is continuing imaging (during imaging) is similar to that of step S901. A description thereof will thus be omitted.

If, in step S913 of FIG. 9, the CPU 212 (second authentication unit 508) determines that the user is continuing imaging (during imaging) (YES in step S913), the processing returns to step S913. In other words, the CPU 212 (second authentication unit 508) waits in step S913 until the user is determined to not be continuing imaging (no imaging).

If, in step S913 of FIG. 9, the CPU 212 (second authentication unit 508) determines that the user is not continuing imaging (no imaging) (NO in step S913), the processing proceeds to step S914.

In step S914 of FIG. 9, the authentication state management unit 521 updates the second authentication state in the authentication state table 570 illustrated in FIG. 5F to “unauthenticated”.

If, in step S910 of FIG. 9, the CPU 212 (second authentication unit 508) determines that the second authentication performed in step S909 is not successful (is failed) (NO in step S910), the processing proceeds to step S915.

In step S915 of FIG. 9, the authentication state management unit 521 updates the second authentication state in the authentication state table 570 illustrated in FIG. 5F to “unauthenticated”.

In step S916 of FIG. 9, the other person use detection unit 509 performs processing for detecting another person's use. Specifically, the other person use detection unit 509 detects whether the use of the camera 100 by a person other than the one authenticated by the first authentication (another person) is suspected.

In step S917 of FIG. 9, the first authentication state invalidation unit 510 determines whether another person's use is detected in step S916.

If, in step S917 of FIG. 9, the first authentication state invalidation unit 510 determines that another person's use is detected in step S916 (YES in step S917), the processing proceeds to step S918.

In step S918 of FIG. 9, the first authentication state invalidation unit 510 updates the first authentication state in the authentication state table 570 illustrated in FIG. 5F to “unauthenticated” and further deletes the personal ID via the authentication state management unit 521. The first authentication can thereby be invalidated when another person's use is suspected.

When the processing of step S918 in FIG. 9 is completed, the processing proceeds to step S919. If, in step S917 of FIG. 9, the first authentication state invalidation unit 510 determines that another person's use is not detected in step S916 (NO in step S917), the processing proceeds to step S919.

In step S919 of FIG. 9, the CPU 212 (second authentication unit 508) provides display to inform the user that the authentication is failed on the display device 214 using the authentication state display unit 523. With the processing of this step S919 completed, the processing returns to step S901.

When the processing of step S914 in FIG. 9 is completed, the processing proceeds to step S920.

If, in step S901 of FIG. 9, the CPU 212 (second authentication unit 508) determines that the first authentication is not valid or the user is not continuing imaging (not during imaging) (NO in step S901), the processing proceeds to step S920.

In step S920 of FIG. 9, the CPU 212 (second authentication unit 508) updates the display on the display device 214 using the authentication state display unit 523. For example, if imaging is no longer in progress, the authentication state display unit 523 quits displaying the authentication state. For example, if imaging is in progress but the first authentication state is “unauthenticated”, the authentication state display unit 523 displays that the first authentication state is “unauthenticated” by using a message or icon.

With the processing of step S920 in FIG. 9 completed, the processing of the flowchart of FIG. 9 ends.

### [Other Person Use Detection Processing]

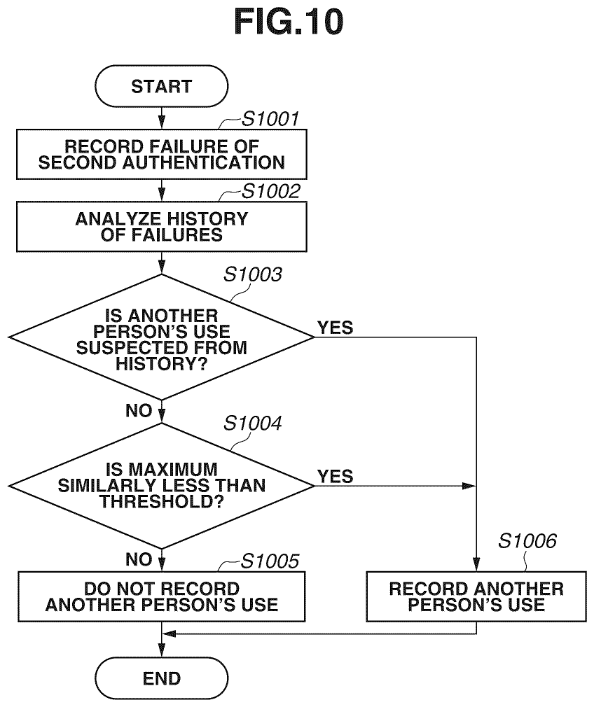

FIG. 10 is a flowchart illustrating an example of a detailed processing procedure for the other person use detection processing in step S916 of FIG. 9. The processing of the flowchart illustrated in this FIG. 10 is mainly performed by the other person use detection unit 509 on the CPU 212.

In step S1001 of FIG. 10, the other person use detection unit 509 records the failure of the second authentication. For example, the other person use detection unit 509 here records the time of the failure and the similarity score at that time.

In step S1002 of FIG. 10, the other person use detection unit 509 analyzes a history of failures of the second authentication recorded in step S1001 for any pattern indicating another person's use. Specifically, if the number of failures of the second authentication within a predetermined recent time range exceeds a threshold, the other person use detection unit 509 determines that another person is using the camera 100. Here, the other person use detection unit 509 may count failures occurring during the same imaging session collectively as one failure. Alternatively, the other person use detection unit 509 may count only failures with similarities lower than a predetermined threshold. Moreover, while the other person use detection unit 509 records only failures in step S1001, successes may also be recorded. For example, the other person use detection unit 509 records the success of the second authentication immediately before step S911 of FIG. 9. The other person use detection unit 509 may be configured to not count failures in an imaging session if the second authentication succeeds at least once in the same imaging session.

In step S1003 of FIG. 10, the other person use detection unit 509 determines whether another person's use is suspected from the history of failures of the second authentication based on the analysis of step S1002.

If, in step S1003 of FIG. 10, the other person use detection unit 509 determines that another person's use is not suspected from the history of failures of the second authentication (NO in step S1003), the processing proceeds to step S1004.

In step S1004 of FIG. 10, the other person use detection unit 509 determines whether the maximum similarity obtained during the collation performed in step S909 of FIG. 9 is less than a predetermined threshold. Specifically, in step S909, the other person use detection unit 509 acquires the similarities with the plurality of registered feature vectors of the same personal ID. In this step, the other person use detection unit 509 obtains the highest similarity among the similarities acquired, and determines whether the similarity is less than the predetermined threshold. The reason is that the similarities with the same person can drop under poor imaging conditions. However, such similarities still tend to be high compared to those with other people. In this step, a threshold is set to enable a determination that the person is obviously someone else, and another person is determined if the maximum similarity falls below the threshold.

If, in step S1004 of FIG. 10, the other person use detection unit 509 determines that the maximum similarity obtained during the collation performed in step S909 of FIG. 9 is not less than the predetermined threshold (NO in step S1004), the processing proceeds to step S1005.

In step S1005 of FIG. 10, the other person use detection unit 509 determines that no other person is using the camera 100, and does not record another person's use (records the absence of another person's use). Specifically, the other person use detection unit 509 retains a flag indicating another person's use in the memory unit 213, and turns the flag off.

If, in step S1004 of FIG. 10, the other person use detection unit 509 determines that the maximum similarity obtained during the collation performed in step S909 of FIG. 9 is less than the predetermined threshold (YES in step S1004), the processing proceeds to step S1006. If, in step S1003 of FIG. 10, the other person use detection unit 509 determines that another person's use is suspected from the history of failures of the second authentication (YES in step S1003), the processing proceeds to step S1006.

In step S1006 of FIG. 10, the other person use detection unit 509 determines that another person is using the camera 100, and records another person's use. Specifically, the other person use detection unit 509 turns on the flag indicating another person's use in the memory unit 213.

When the processing of step S1005 in FIG. 10 is completed, or the processing of step S1006 in FIG. 10 is completed, the processing of the flowchart of FIG. 10 ends.

### [First Authentication Invalidation Processing]

FIGS. 11A to 11D are flowcharts illustrating examples of a detailed processing procedure for the first authentication invalidation processing in the method for controlling the camera 100 corresponding to the information processing apparatus according to the present exemplary embodiment. The four types of first authentication invalidation processing illustrated in FIGS. 11A to 11D are mainly performed by the first authentication state invalidation unit 510 on the CPU 212.

FIG. 11A is a flowchart illustrating an example of a detailed processing procedure for first authentication invalidation processing based on elapsed time. The processing of the flowchart illustrated in this FIG. 11A is predicated on periodic activation by a timer.

In step S1101 of FIG. 11A, the first authentication state invalidation unit 510 determines whether the first authentication is successful. Whether the first authentication is successful is determined based on whether the first authentication state in the authentication state table 570 illustrated in FIG. 5F, managed by the authentication state management unit 521, is “authenticated”.

If, in step S1101 of FIG. 11A, the first authentication state invalidation unit 510 determines that the first authentication is successful (YES in step S1101), the processing proceeds to step S1102.

In step S1102 of FIG. 11A, the first authentication state invalidation unit 510 calculates the time elapsed since the success of the first authentication. In the present exemplary embodiment, the first authentication state invalidation unit 510 calculates the time elapsed since the first authentication state of the authentication state table 570 illustrated in FIG. 5F is changed to “authenticated”. The first authentication state invalidation unit 510 can calculate the time elapsed since the success of the first authentication by recording the time when the first authentication state in the authentication state table 570 illustrated in FIG. 5F is changed to “authenticated” and calculating a difference between the recorded time and the current time.

In step S1103 of FIG. 11A, the first authentication state invalidation unit 510 detects execution of the second authentication by the second authentication unit 508. In the present exemplary embodiment, the first authentication state invalidation unit 510 detects whether the second authentication is executed between when this processing is triggered by the timer last time and when this processing is triggered this time.

If, in step S1103 of FIG. 11A, the first authentication state invalidation unit 510 determines that the execution of the second authentication is detected (YES in step S1103), the processing proceeds to step S1104. If the first authentication state invalidation unit 510 determines that the execution of the second authentication is not detected (NO in step S1103), the processing proceeds to step S1107.

In step S1104 of FIG. 11A, the first authentication state invalidation unit 510 determines whether the second authentication detected to be executed in step S1103 is successful.

If, in step S1104 of FIG. 11A, the first authentication state invalidation unit 510 determines that the second authentication detected to be executed in step S1103 is successful (YES in step S1104), the processing proceeds to step S1105.

In step S1105 of FIG. 11A, the first authentication state invalidation unit 510 adds a predetermined time to the expiration time. The initial value of the expiration time shall be initialized to a predetermined expiration time value when the first authentication state in the authentication state table 570 illustrated in FIG. 5F is changed to “authenticated”.

If, in step S1104 of FIG. 11A, the first authentication state invalidation unit 510 determines that the second authentication detected to be executed in step S1103 is not successful (is failed) (NO in step S1104), the processing proceeds to step S1106.

In step S1106 of FIG. 11A, the first authentication state invalidation unit 510 subtracts a predetermined time from the foregoing expiration time.

When the processing of step S1105 in FIG. 11A is completed, or the processing of step S1106 in FIG. 11A is completed, the processing proceeds to step S1107.

In step S1107 of FIG. 11A, the first authentication state invalidation unit 510 determines whether the elapsed time calculated in step S1102 has passed the currently acquired expiration time.

If, in step S1107 of FIG. 11A, the first authentication state invalidation unit 510 determines that the elapsed time calculated in step S1102 has passed the currently acquired expiration time (YES in step S1107), the processing proceeds to step S1108.

In step S1108 of FIG. 11A, the first authentication state invalidation unit 510 updates the first and second authentication states in the authentication state table 570 illustrated in FIG. 5F to “unauthenticated” via the authentication state management unit 521, and further deletes the personal ID.

When the processing of step S1108 in FIG. 11A is completed, the processing of flowchart of FIG. 11A ends. If, in step S1101 of FIG. 11A, the first authentication state invalidation unit 510 determines that the first authentication is not successful (is failed) (NO in step S1101), the processing of the flowchart of FIG. 11A ends.

FIG. 11B is a flowchart illustrating an example of a detailed processing procedure for first authentication invalidation processing based on a change in the state of the power supply. The processing of the flowchart illustrated in this FIG. 11B is predicated on being activated when the power supply state changes. Examples of when the power supply state changes include when the camera 100 is powered on, when the camera 100 is powered off, when the camera 100 enters the sleep move, and when the camera 100 resumes from the sleep mode.

In step S1111 of FIG. 11B, the first authentication state invalidation unit 510 determines whether the first authentication is successful. Whether the first authentication is successful is determined based on whether the first authentication state in the authentication state table 570 illustrated in FIG. 5F, managed by the authentication state management unit 521, is “authenticated”.

If, in step S1111 of FIG. 11B, the first authentication state invalidation unit 510 determines that the first authentication is successful (YES in step S1111), the processing proceeds to step S1112.

In step S1112 of FIG. 11B, the first authentication state invalidation unit 510 determines whether the power supply state has changed. In step S1112, the power supply state is determined to have changed if there is at least one change in the power supply state, either from on to off or from off to on.

If, in step S1112 of FIG. 11B, the first authentication state invalidation unit 510 determines that the power supply state has not changed (NO in step S1112), the processing proceeds to step S1113.

In step S1113 of FIG. 11B, the first authentication state invalidation unit 510 determines whether the sleep state has changed. In step S1113, the sleep state is determined to have changed if the camera 100 has at least either entered the sleep mode or resumed from the sleep mode.

If, in step S1113 of FIG. 11B, the first authentication state invalidation unit 510 determines that the sleep state has changed (YES in step S1113), the processing proceeds to step S1114.

If, in step S1112 of FIG. 11B, the first authentication state invalidation unit 510 determines that the power supply state has changed (YES in step S1112), the processing proceeds to step S1114.

In step S1114, the first authentication state invalidation unit 510 updates the first and second authentication states in the authentication state table 570 illustrated in FIG. 5F to “unauthenticated” via the authentication state management unit 521, and further deletes the personal ID.

When the processing of step S1114 in FIG. 11B is completed, the processing of the flowchart of FIG. 11B ends. If, in step S1113 of FIG. 11B, the first authentication state invalidation unit 510 determines that the sleep state has not changed (NO in step S1113), the processing of the flowchart of FIG. 11B ends. If, in step S1111 of FIG. 11B, the first authentication state invalidation unit 510 determines that the first authentication is not successful (is failed) (NO in step S1111), the processing of the flowchart of FIG. 11B also ends.

FIG. 11C is a flowchart illustrating an example of a detailed processing procedure for first authentication invalidation processing based on a distance from or connection state with a device. The processing of the flowchart illustrated in this FIG. 11C is predicated on periodic activation by a timer. In the processing of the flowchart illustrated in FIG. 11C, a device carried by the user and the camera 100 shall perform processing for communication connection therebetween in advance. Examples include where a smartphone carried by the user and the camera 100 perform pairing processing for Bluetooth® connection in advance.

In step S1121 of FIG. 11C, the first authentication state invalidation unit 510 determines whether the first authentication is successful. Whether the first authentication is successful is determined based on whether the first authentication state in the authentication state table 570 illustrated in FIG. 5F, managed by the authentication state management unit 521, is “authenticated”.

If, in step S1121 of FIG. 11C, the first authentication state invalidation unit 510 determines that the first authentication is successful (YES in step S1121), the processing proceeds to step S1122.

In step S1122 of FIG. 11C, the first authentication state invalidation unit 510 determines whether the connection had deteriorated beyond a predetermined condition. In this step, examples include where the radio wave strength of the communication connection has dropped below a predetermined level.

If, in step S1122 of FIG. 11C, the first authentication state invalidation unit 510 determines that the connection has deteriorated beyond the predetermined condition (YES in step S1122), the processing proceeds to step S1123.

In step S1123 of FIG. 11C, the first authentication state invalidation unit 510 updates the first and second authentication states in the authentication state table 570 illustrated in FIG. 5F to “unauthenticated” via the authentication state management unit 521, and further deletes the personal ID.

When the processing of step S1123 in FIG. 11C is completed, the processing of the flowchart of FIG. 11C ends. If, in step S1122 of FIG. 11C, the first authentication state invalidation unit 510 determines that the connection has not deteriorated beyond the predetermined condition (NO in step S1122), the processing of the flowchart of FIG. 11C ends. If, in step S1121 of FIG. 11C, the first authentication state invalidation unit 510 determines that the first authentication is not successful (is failed) (NO in step S1121), the processing of the flowchart of FIG. 11C also ends.

FIG. 11D is a flowchart illustrating an example of a detailed processing procedure for first authentication invalidation processing based on the input of the user's explicit operation for invalidation. The processing of the flowchart illustrated in this FIG. 11D is constantly performed while the power of the camera 100 is on.

In step S1131 of FIG. 11D, the first authentication state invalidation unit 510 determines whether the first authentication is successful. Whether the first authentication is successful is determined based on whether the first authentication state in the authentication state table 570 illustrated in FIG. 5F, managed by the authentication state management unit 521, is “authenticated”.

If, in step S1131 of FIG. 11D, the first authentication state invalidation unit 510 determines that the first authentication is successful (YES in step S1131), the processing proceeds to step S1132.

In step S1132 of FIG. 11D, the first authentication state invalidation unit 510 waits for the user's invalidation operation. A not-illustrated switch button is disposed on the camera 100, and the invalidation operation in this step shall be regarded as performed when the user presses the switch button. The invalidation operation may be made selectable from a menu displayed on the touchscreen.

In step S1133 of FIG. 11D, the first authentication state invalidation unit 510 determines whether the user's invalidation operation is detected.

If, in step S1133 of FIG. 11D, the first authentication state invalidation unit 510 determines that the user's invalidation operation is detected (YES in step S1133), the processing proceeds to step S1134.

In step S1134 of FIG. 11D, the first authentication state invalidation unit 510 updates the first and second authentication states in the authentication state table 570 illustrated in FIG. 5F to “unauthenticated” via the authentication state management unit 521, and further deletes the personal ID.

When the processing of step S1134 in FIG. 11D is completed, the processing of the flowchart of FIG. 11D ends. If, in step S1133 of FIG. 11D, the first authentication state invalidation unit 510 determines that the user's invalidation operation is not detected (NO in step S1133), the processing of the flowchart of FIG. 11D ends. If, in step S1131 of FIG. 11D, the first authentication state invalidation unit 510 determines that the first authentication is not successful (is failed) (NO in step S1131), the processing of the flowchart of FIG. 11D also ends.

### [Authentication State Storage Processing]

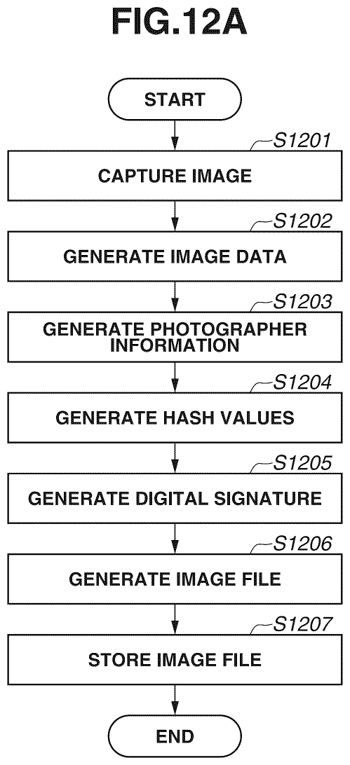

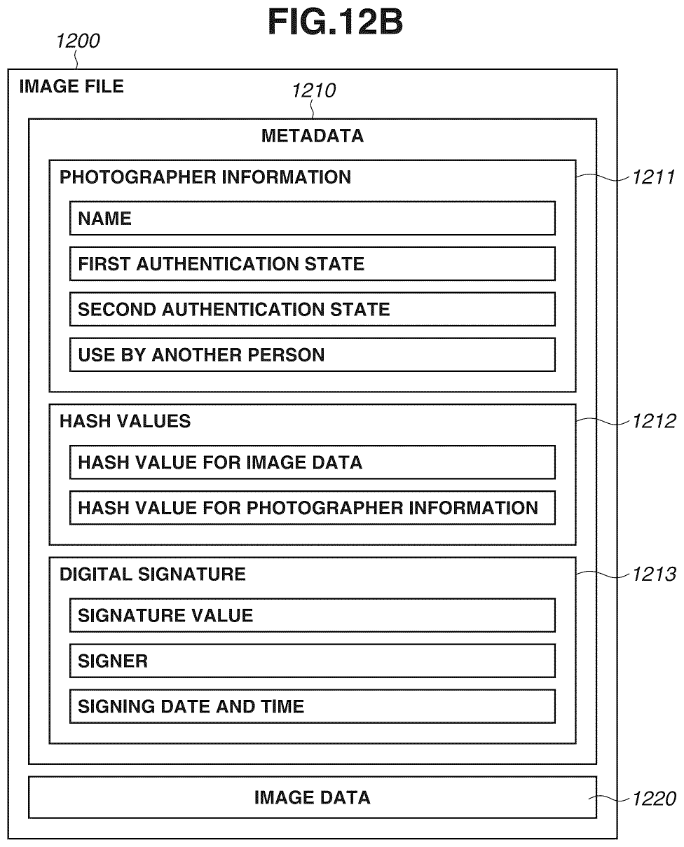

FIG. 12A is a flowchart illustrating an example of a detailed processing procedure for authentication state storage processing in the method for controlling the camera 100 corresponding to the information processing apparatus according to the first exemplary embodiment. The processing of the flowchart illustrated in this FIG. 12A is mainly performed by the authentication state storage unit 522 on the CPU 212. FIG. 12B is a diagram illustrating the first exemplary embodiment, illustrating a configuration example of an image file 1200 stored by the authentication state storage unit 522.

The processing of the flowchart illustrated in FIG. 12A is processing for generating and storing the image file 1200 illustrated in FIG. 12B. Specifically, the processing of the flowchart illustrated in FIG. 12A is processing for storing, along with image data 1220 on an object image captured by the user, photographer information 1211, hash values 1212, and a digital signature 1213 as metadata 1210 in association with the image data 1220. The processing of the flowchart illustrated in FIG. 12A is executed when the release button 121 is pressed down to the second stroke.

In step S1201 of FIG. 12A, the authentication state storage unit 522 captures an image of the object via the imaging unit 511. Specifically, for example, the imaging unit 511 performs imaging processing on the object by converting the light received by the image sensor 211 into an electrical signal.

In step S1202 of FIG. 12A, the authentication state storage unit 522 generates the image data 1220 on the object image via the imaging unit 511. Specifically, for example, the imaging unit 511 applies image processing such as development processing and encoding processing to the electrical signal obtained by the imaging processing of step S1201 to generate the image data 1220 on the object image.

In step S1203 of FIG. 12A, the authentication state storage unit 522 generates photographer information 1211 about the user capturing the image data 1220 on the object image. Specifically, the authentication state storage unit 522 acquires the authentication state table 570 illustrated in FIG. 5F. The authentication state storage unit 522 acquires personal information corresponding to the personal ID via the registration data management unit 505. In the present exemplary embodiment, “name” is acquired as the personal information. The authentication state storage unit 522 generates photographer information 1211 including the user's name, the first authentication state, the second authentication state, and the information about the presence or absence of another person's use from the information included in the authentication state table 570.

In step S1204 of FIG. 12A, the authentication state storage unit 522 executes a hash function on the binary data of the image data 1220 on the object image and that of the photographer information 1211 to generate respective hash values 1212.

In step S1205 of FIG. 12A, the authentication state storage unit 522 generates the digital signature 1213. The digital signature 1213 includes information indicating a signature value, signer, and signing date and time. The signature value is generated by encrypting the hash values 1212 generated in step S1204 with a secret key prepared in advance. The public key to be paired with the secret key used here is also stored in the digital signature 1213. In the present exemplary embodiment, information indicating the manufacturer of the camera 100 is stored as the signer. The model of the camera 100 may be used for the signer instead of the manufacturer. The date and time when the generation of the digital signature 1213 is completed is stored as the signing date and time.

In step S1206 of FIG. 12A, the authentication state storage unit 522 generates the image file 1200 by attaching the photographer information 1211, the hash values 1212, and the digital signature 1213 to the image data 1220 on the object image as the metadata 1210. If the image data 1220 is a still image, the image file 1200 is generated based on a Joint Photographic Experts Group (JPEG) format. If the image data 1220 is a moving image, the image file 1200 is generated based on a Moving Picture Experts Group (MPEG) format.

In step S1207 of FIG. 12A, the authentication state storage unit 522 stores the image file 1200 generated in step S1206 into the memory unit 213. The memory unit 213 also includes a storage medium detachably attachable to the camera 100, in which case the image file 1200 may be stored in the storage medium, for example. With the processing of step S1207 completed, the processing of the flowchart of FIG. 12A ends.

That the image file 1200 has not been tampered with can be confirmed by the following verification method. The hash values 1212 are initially restored from the signature value using the public key. Moreover, a hash value for the image data 1220 and a hash value for the photographer information 1211 are determined again. If the hash values 1212 restored and the hash values determined again match, the image file 1200 can be determined to not have been tampered with. On the other hand, if the hash values 1212 restored and the hash values determined again do not match, the image file 1200 can be determined to have been tampered with. Suppose that someone tampers with the image data 1220. Since the signature value is encrypted with the secret key, the person tempering with the image data 1220 is unable to modify the signature value. If the image data 1220 has been tampered with, the hash value determined from the image data 1220 and the hash value restored therefore do not match. In such a manner, data tampering can be detected.

In the example illustrated in FIG. 12B, the image file 1200 is stored with the hash values 1212 included. However, the image file 1200 may be configured to not include the hash values 1212, since the hash values 1212 can be calculated again from the image data 1220 and the photographer information 1211 included in the image file 1200.

In the case of moving images, pressing the release button 121 down to the second stroke starts the capturing of a moving image, and pressing the release button 121 down to the second stroke again completes the capturing of the moving image. Moving image data is generated by the processing of steps S1201 and S1202 of FIG. 12A. Hash values for the moving image data are calculated and stored instead of the hash values for the image data. The image data 1220 on the moving image and the metadata 1210 are stored together as the image file 1200 of the moving image.

### [Line of Sight Detection Processing]

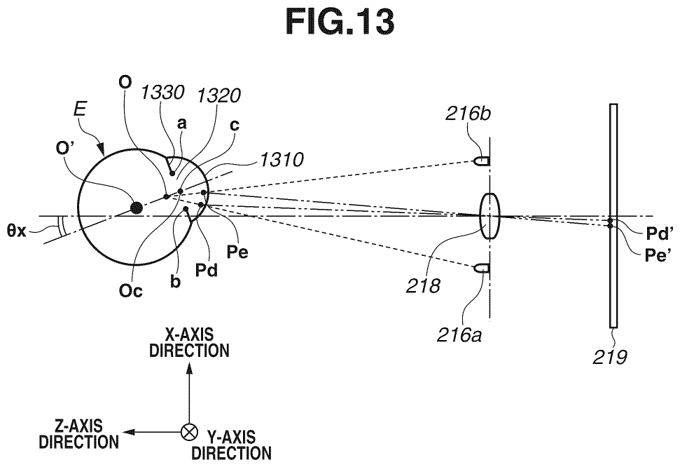

FIG. 13 is a diagram illustrating the first exemplary embodiment, a diagram for describing the principle of the user's line of sight detection processing. In this FIG. 13, components similar to those illustrated in FIGS. 2 and 3 are denoted by the same reference numerals, and a detailed description thereof will be omitted. FIG. 13 illustrates an XYZ coordinate system corresponding to that illustrated in FIG. 2.

As illustrated in FIG. 13, the light sources 216a and 216b are located substantially symmetrically about the optical axis of the light receiving lens 218, and illuminate the user's eye E. Part of the light emitted from the light sources 216a and 216b and reflected at the user's eye E is focused on the eye image sensor 219 by the light receiving lens 218. In FIG. 13, a cornea 1310, a pupil 1320, and an iris 1330 are illustrated on the user's eye E.

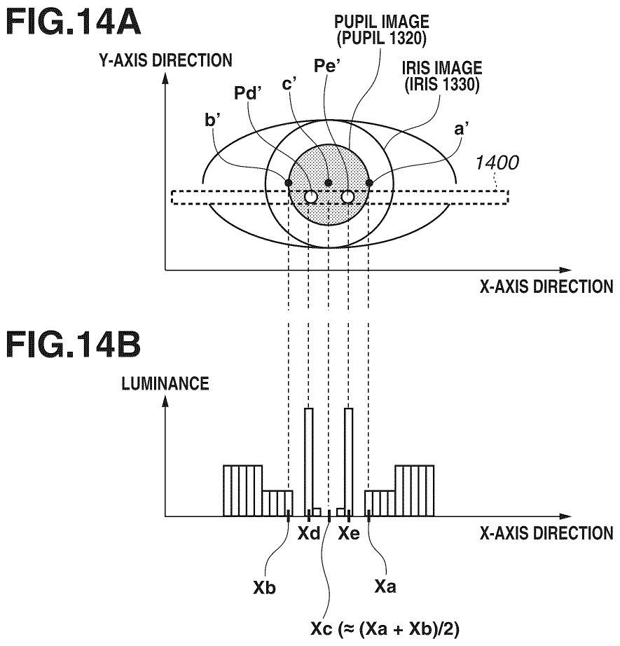

FIGS. 14A and 14B are diagrams illustrating the first exemplary embodiment, diagrams for describing the user's line of sight detection processing.

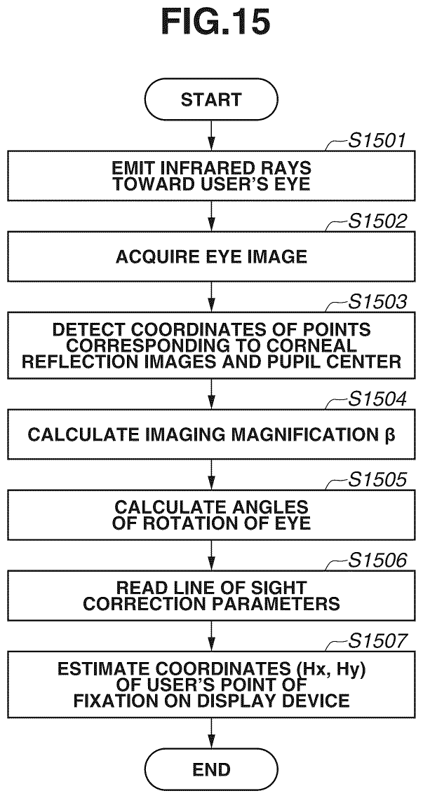

Specifically, FIG. 14A is a schematic diagram illustrating an eye image captured by the eye image sensor 219 (eye optical image projected on the eye image sensor 219). In this FIG. 14A, components similar to those illustrated in FIG. 13 are denoted by the same reference numerals. FIG. 14B is a chart illustrating the output strength of the eye image sensor 219 in terms of luminance. FIG. 15 is a flowchart illustrating an example of a detailed processing procedure for the line of sight detection processing in the method for controlling the camera 100 corresponding to the information processing apparatus according to the first exemplary embodiment.

In step S1501 of FIG. 15, the CPU 212 controls driving of the light sources 216a and 216b via the light source driving circuit 305 so that infrared rays are emitted toward the user's eye E. An optical image of the user's eye E illuminated by the infrared rays is formed on the eye image sensor 219 through the light receiving lens 218 and photoelectrically converted by the eye image sensor 219. A processable electrical signal of the eye image is thereby obtained.

In step S1502 of FIG. 15, the CPU 212 acquires the eye image (eye image signal; electrical signal of the eye image) from the eye image sensor 219 via the line of sight detection circuit 301.

Through the processing of steps S1503 and S1504 in FIG. 15, the CPU 212 acquires eye information about the position of the eye E relative to the viewfinder from the eye image acquired in step S1502.

Specifically, in step S1503 of FIG. 15, the CPU 212 detects the coordinates of corneal reflection images Pd and Pe of the light sources 216a and 216b and a point corresponding to a pupil center c from the eye image acquired in step S1502.

In FIG. 13, the infrared rays emitted from the light sources 216a and 216b illuminate the cornea 1310 of the user's eye E. Here, the corneal reflection images Pd and Pe formed by part of the infrared rays reflected at the surface of the cornea 1310 are collected through the light receiving lens 218 and focused on the eye image sensor 219, whereby corneal reflection images Pd′ and Pe′ are formed in the eye image. Similarly, light beams from ends a and b of the pupil 1320 are also focused on the eye image sensor 19, whereby respective pupil end images a′ and b′ are formed in the eye image. FIG. 14B is a chart illustrating luminance information (luminance distribution) about a region 1400 in the eye image of FIG. 14A. FIG. 14B illustrates the luminance distribution along the X-axis direction, with the horizontal direction of the eye image as the X-axis direction and the vertical direction as the Y-axis direction.

In the first exemplary embodiment, the coordinates of the corneal reflection images Pd′ and Pe′ in the X-axis direction (horizontal direction) will be referred to as coordinates Xd and Xe, respectively. The coordinates of the pupil end images a′ and b′ in the X-axis direction will be referred to as coordinates Xa and Xb, respectively. As illustrated in FIG. 14B, extremely high levels of luminance are obtained at the coordinates Xd and Xe of the corneal images Pd′ and Pe′. In the region from the coordinate Xa to the coordinate Xb, which corresponds to the region of the pupil 1320 (region of a pupil image obtained by focusing the light beams from the pupil 1320 upon the eye image sensor 219), extremely low levels of luminance are obtained except at the coordinates Xd and Xe. In the region of the iris 1330 outside the pupil 1320 (region of an iris image outside the pupil image, obtained by focusing the light beams from the iris 1330), luminance intermediate between the foregoing two types of luminance is obtained. For example, luminance intermediate between the foregoing two types of luminance is obtained in the region where the X coordinate (coordinate in the X-axis direction) is greater than the coordinate Xa and the region where the X coordinate is less than the coordinate Xb. From the luminance distribution such as illustrated in FIG. 14B, the coordinates Xd and Xe of the corneal reflection images Pd′ and Pe′ and the coordinates Xa and Xb of the pupil end images a′ and b′ can be obtained. For example, the coordinates where the luminance is extremely high can be obtained as the coordinates of the corneal reflection images Pd′ and Pe′. Coordinates where the luminance is extremely low can be obtained as the coordinates of the pupil end images a′ and b′. In FIG. 13, if the angle of rotation Ox of the optical axis of the eye E relative to the optical axis of the light receiving lens 218 is small, the coordinate Xc of the pupil center image c′ (center of the pupil image) obtained by focusing the light beam from the pupil center C upon the eye image sensor 219 can be expressed as Xc˜(Xa+Xb)/2. In other words, the coordinate Xc of the pupil center image c′ can be calculated from the coordinates Xa and Xb of the pupil end images a′ and b′. In such a manner, the CPU 212 can estimate the coordinates of the corneal reflection images Pd′ and Pe′ and the coordinates of the pupil center image c′.

In step S1504 of FIG. 15, the CPU 212 calculates an imaging magnification β of the eye image. The imaging magnification B is a magnification determined by the position of the eye E relative to the light receiving lens 218, and can be calculated using a function of a distance ΔP=Xe−Xd between the corneal reflection images Pd′ and Pe′.

In step S1505 of FIG. 15, the CPU 212 calculates the angles of rotation of the optical axis of the eye E relative to the optical axis of the light receiving lens 218. The X coordinate of the midpoint between the corneal reflection images Pd and Pe is substantially the same as the X coordinate of the center of curvature O of the cornea 1310. The angle of rotation Ox of the eye E within the ZX plane (plane perpendicular to the Y-axis) can thus be calculated by the following Eq. (1):

$$β \times O c \times SIN ( θ x ) \approx \{ Xd + Xe ) / 2 \} - Xc , \qquad ( 1 )$$

where Oc is a standard distance from the center of curvature O of the cornea 1310 to the center c of the pupil 1320. The angle of rotation θy of the eye E within the ZY plane (plane perpendicular to the X-axis) can also be calculated by a method similar to the foregoing method for calculating the angle of rotation ex.

In step S1506 of FIG. 15, the CPU 212 reads line of sight correction parameters stored in the memory unit 213. Specifically, the line of sight correction parameters refer to parameters Ax, Bx, Ay, and By in Eqs. (2) and (3) used in step S1507 of FIG. 15.

In step S1507 of FIG. 15, the CPU 212 estimates coordinates (Hx, Hy) of the user's point of fixation on the screen on the display device 214, using the angles of rotation θx and θy calculated in step S1505. Assuming that the coordinates (Hx, Hy) of the point of fixation are ones corresponding to the pupil center c, the coordinates (Hx, Hy) of the point of fixation can be calculated by the following Eqs. (2) and (3):

$$Hx = m \times ( A x \times θ x + Bx ) , \qquad ( 2 )$$

$$and$$

$$Hy = m \times ( A y \times θ y + B y ) . \qquad ( 3 )$$

The parameter m in Eqs. (2) and (3) is a constant determined depending on the configuration of the optical system for performing the line of sight detection, a conversion factor for converting the angles of rotation θx and θy into coordinates corresponding to the pupil center c on the screen of the display device 214. This parameter m is determined in advance and stored in the memory unit 213. The parameters Ax, Bx, Ay, and Bx in Eqs. (2) and (3) are the line of sight correction parameters read in the foregoing step S1506.

The line of sight correction parameters will be described.

The point of fixation can be difficult to estimate with high accuracy due to factors such as individual differences in the shape of the human eye E. Specifically, as illustrated in FIG. 4B, there occurs a discrepancy between the actual point of fixation B (410B) and the estimated point of fixation C (410C). In FIG. 4B, the user is gazing at the human figure while the camera 100 erroneously estimates that the user is gazing at the background. In such a situation, appropriate focus detection and adjustment are difficult. The line of sight correction parameters are parameters for correcting such a discrepancy. The line of sight correction parameters can be obtained through calibration for line of sight detection. The calibration is performed, for example, by highlighting the plurality of indices 411 to 415 located at different positions on the screen of the display device 214 as illustrated in FIG. 4C, and having the user look at the indices. Line of sight detection operations are performed with each index gazed at, and the line of sight correction parameters suitable for the user are determined from the plurality of points of fixation calculated (estimated positions) and the coordinates of the plurality of indices. The method for displaying the indices is not limited in particular as long as the positions for the user to look at are suggested. Graphical representations of the indices may be displayed. At least either of luminance and color of an image (for example, captured image) may be changed to display the indices.

When the processing of step S1507 in FIG. 15 is completed, the processing of the flowchart of FIG. 15 ends.

### [Left and Right Eye Determination Processing]

Left and right eye determination processing by the left and right eye determination unit 503 will be described.

The left and right eye determination processing is processing for determining which of the left and right eyes an eye image is acquired from. As described above, in the line of sight detection processing used in the present exemplary embodiment, there occurs a discrepancy between the actual point of fixation and the estimated point of fixation. One of the reasons is that the fovea of the eye E is not located on the visual axis. The fovea refers to the central region of the macula in the retina of the eye E. The fovea is located 4 to 8 degrees offset toward the ear from the visual axis. This offset shifts the estimated point of fixation toward the nose from the actual point of fixation. In the present exemplary embodiment, the left and right eye determination unit 503 performs the left and right eye determination processing based on the shift. If the estimated point of fixation is shifted to the left from the actual point of fixation as viewed from the user, the eye from which the eye image is acquired can be determined to be the right eye. Conversely, if the estimated point of fixation is shifted to the right, the eye from which the eye image is acquired can be determined to be the left eye. The specific method for the left and right eye determination processing is not limited thereto. For example, a neural network that outputs a determination result about which of the left and right eyes an eye image is acquired from with the eye image as an input can be constructed using eye images acquired from the left and right eyes of the user as training data. Which of the left and right eyes the eye image is acquired may be determined using such a neural network.

### Effects of Present Exemplary Embodiment

To guarantee that an image or moving image is captured by an intended person, it is necessary to perform authentication at imaging time. However, to guarantee that the imaging is not performed by another person (is performed by the same person), it is necessary to perform the authentication with low false acceptance rate settings. Such settings typically increase the false rejection rate. The authentication at imaging time can thus fail even when the same person captures images. In the use cases of photography, there is no second chance to capture the same image. For example, for professional photographers, decisive moments in sports and news scoops are just an instant. That authentication is unable to be performed at that moment is a significant issue. In other words, the user (photographer) capturing a decisive moment is unable to be guaranteed to be the photographer themselves.

In the present exemplary embodiment, authentication using a plurality of pieces of biological information (both eyes) is performed by the first authentication at non-imaging time (before imaging), with low false acceptance rate settings. The authentication using the plurality of pieces of biological information (both eyes) can further reduce the false acceptance rate. In addition, authentication is performed with low false rejection rate settings by the second authentication at imaging time (during imaging). This can suppress the possibility of false rejection during the second authentication while suppressing the possibility of false acceptance by the first authentication.

In the first authentication, the false rejection rate is high due to the low false acceptance rate settings.

The same person can therefore be rejected at the first authentication. However, the authentication can be attempted again since imaging is not in progress. This means no issue in terms of use. In the second authentication, the possibility of false acceptance increases. In this regard, in the present exemplary embodiment, the first authentication state is invalidated under various conditions to prevent the possibility of another person being accepted. More specifically, if another person's use is suspected during the second authentication, the first authentication is invalided. The first authentication is also invalidated depending on the time elapsed since the success of the first authentication, a change in the power supply state, a change in the distance from or connection state with a peripheral device, and the acceptance of the user's explicit operation for invalidation. The possibility of another person's use is thereby reduced to suppress the acceptance of another person at the second authentication.

In addition, in the present exemplary embodiment, the results of the first authentication and the second authentication are separately recorded as the photographer information 1211 in the metadata 1210 of the image file 1200. If only the first authentication succeeds and the second authentication fails, the success of the first authentication is therefore recorded in the metadata 1210. If the second authentication also succeeds, the success of both authentications is explicitly recorded in the image file 1200. The more authentications succeed, the higher the likelihood can thus be made that the image is captured by the user (photographer). Furthermore, the presence or absence of another person's use is also recorded as the photographer information 1211 in the metadata 1210 of the image file 1200. In cases where only the first authentication is successful and the second authentication fails, whether the use by another person is even suspected can thus be shown. The likelihood that the image is captured by the user (photographer) can thereby also be increased.

The camera 100 according to the first exemplary embodiment described above is an information processing apparatus that performs user authentication. The camera 100 according to the first exemplary embodiment includes the registration data management unit 505 that manages the authentication registration information about users to permit the use of the camera 100. The camera 100 according to the first exemplary embodiment includes the first authentication unit 507 that authenticates the authentication target user by using a plurality of pieces of authentication target information acquired from a plurality of different parts of the authentication target user and the authentication registration information managed by the registration data management unit 505. The camera 100 according to the first exemplary embodiment further includes the second authentication unit 508 that performs, after the first authentication by the first authentication unit 507 succeeds, the second authentication on the authentication target user by using authentication target information acquired from one of the plurality of parts of the authentication target user.

Such a configuration can improve the accuracy of user authentication by the camera 100 (information processing apparatus) while preventing a decrease in usability.

A modification of the first exemplary embodiment will be described. In the foregoing first exemplary embodiment, only “name” is used as the personal information to be managed by the registration data management unit 505. However, information other than the name may be used. For example, in the case of a camera 100 used in a company, “employee number” assigned to each employee may be stored. Alternatively, account information such as an account name for a web service may be input. The account information may be used as the personal information when the web service is accessed and successfully logged in to. A token may be issued upon successful access to the web service, and the token may also be stored as the personal information. The authentication state storage unit 522 may store such pieces of personal information as the photographer information 1211 in the metadata 1210 of the image file 1200.

In the foregoing first exemplary embodiment, the first authentication unit 507 and the second authentication unit 508 use the same feature vector calculation unit 502. However, the first authentication unit 507 and the second authentication unit 508 acquire eye images of different tendencies. Specifically, to capture eye images with the intention of actively authenticating the user, the first authentication unit 507 acquires eye images under conditions such as the eye E being wide open. By contrast, the second authentication unit 508 attempts to capture the user's eye image during imaging and perform authentication, and there can thus be a wide variation of eye images with various gazing angles. For the neural network used in the first authentication unit 507, a model trained with eye images intended for the first authentication is thus used. For the neural network used in the second authentication unit 508, a model trained with eye images intended for the second authentication is used. This can further improve the authentication accuracy. The use of an authentication method with a low false acceptance rate for the first authentication and an authentication method with a low false rejection rate for the second authentication may be implemented by methods other than using different thresholds or models. For example, as discussed in Japanese Patent No. 7346528, the feature vectors to be used during registration and during collation can be calculated by different methods for improved performance. Such authentication methods may be employed.

In the foregoing first exemplary embodiment, the number of registered users is one. In registering a different person, all the data retained by the registration data management unit 505 is thus erased and registration is performed again.

In other words, when the registration processing is activated, the data in the registration data management unit 505 is deleted. Alternatively, an invalidation flag is set to not use that data for the subsequent first and second authentications without deleting the data. However, the camera 100 may be configured so that a plurality of users can be registered. In such a case, registration information (personal information and feature vectors) with a different personal ID are registered in the registration data management unit 505 each time the registration processing is activated. It will be understood that processing for preventing redundant registration of the same person may be added. For example, if names are the same, a message that the user has already been registered may be displayed and the registration processing may be ended. Which personal ID the user who is using the camera 100 has is determined when the first round of authentication in the first authentication processing is performed. If there is a plurality of personal IDs with similarities exceeding a predetermined threshold, the user may be authenticated with the personal ID of the highest similarity. Alternatively, the first authentication may be ended with a failure. Furthermore, the registered feature vectors for use in the second round of authentication in the first authentication processing and the second authentication processing may be limited to those of that personal ID. More specifically, in step S822 or S823 of FIG. 8B illustrating the first authentication processing, the CPU 212 (first authentication unit 507) extracts only the record including the personal ID identified in step S810 of FIG. 8A from the first authentication registered right eye feature vector table 540 or the first authentication registered left eye feature vector table 550. In step S908 of FIG. 9 illustrating the second authentication processing, the CPU 212 (second authentication unit 508) extracts only the records with the identified personal ID from the second authentication registered feature vector table 560. In the foregoing first authentication processing and second authentication processing, the authentications are performed using only the feature vectors of the extracted records. This reduces the numbers of vectors to be compared in the second round of authentication in the first authentication processing and the second authentication processing. This can improve the authentication accuracy. The reason is that the authentication problem can be simplified from 1: N identification to 1:1 identification. Since the feature vectors to be collated decrease, the processing time can also be reduced.

In the foregoing first exemplary embodiment, the registration data management unit 505 retains the first authentication registered right eye feature vector table 540, the first authentication registered left eye feature vector table 550, and the second authentication registered feature vector table 560 as separate tables. However, such a configuration is inefficient since there are redundant “feature vectors 1r”. The registration data management unit 505 may therefore retain a single integrated table. In doing so, information indicating which authentication each record is used for, the first authentication or the second authentication, and information indicating which of the left and right eyes each record is acquired from may be stored. The registered feature vectors to be used are then selected during the first authentication and the second authentication. In the foregoing first exemplary embodiment, the first authentication and the second authentication use respective different feature vectors registered. However, the same feature vectors may be used. In such a case, the registration data management unit 505 does not need to retain the first authentication registered right eye feature vector table 540, the first authentication registered left eye feature vector table 550, and the second authentication registered feature vector table 560, and may manage the feature vectors using a single table.

In the foregoing first exemplary embodiment, during the second authentication processing, the authentication state display unit 523 displays the authentication result on the display device 214 (steps S912, S919, and S920 of FIG. 9).

However, at imaging time, the image being captured by the image sensor 211 is already displayed on the display device 214. The user is therefore considered to want to concentrate on imaging. The authentication result is thus desirably displayed in a manner not interfering with the imaging. For that purpose, the authentication state display unit 523 may be modified as follows: For example, the authentication state display unit 523 displays an indication of a success or failure at an end of the screen of the display device 214. Alternatively, the authentication state display unit 523 may determine the display position based on the position of fixation of the user on the display device 214, which is obtained in step S1507 of FIG. 15 illustrating the line of sight detection processing. For example, the indication may be displayed at a position far from the position of fixation. Note that the display position can be difficult to find if changed in many ways. Possible display positions may therefore be determined to be near the four corners in advance, and which of the display positions to display the indication at may be determined based on the position of fixation. More specifically, an icon is displayed at the farthest predetermined position when seen from the position of fixation. The display in steps S904 and S906 may be omitted, in which case steps S904 and S906 can be omitted.

In the foregoing first exemplary embodiment, during the second authentication processing, only the authentication state of the second authentication is displayed as the method for displaying the authentication state in steps S912 and S919 of FIG. 9. However, the authentication state of the first authentication may be displayed as well. Similarly, the authentication states of both the first authentication and the second authentication may be displayed in step S920 of FIG. 9. The authentication states are described to not be displayed at the beginning of the second authentication processing. However, the authentication states may already be displayed on the display device 214 when the second authentication processing starts, i.e., when the user looks into the viewfinder. The authentication state display unit 523 can be configured to display such authentication states.

In the foregoing first exemplary embodiment, in the authentication state storage processing by the authentication state storage unit 522, the entire content of the authentication state table 570 managed by the authentication state management unit 521 is stored as the metadata 1210. However, the entire content does not need to be stored, and the content may be processed before storage. For example, only “name” may be stored. “Name” may be stored only when the first and second authentication states are both “authenticated”. In other cases, a value indicating unknown may be stored in “name”. While the first authentication state and the second authentication state are distinguished, the states may be integrated into one item “authentication state”. “Authenticated” may be stored only when the first and second authentication states are both “authenticated”. In other cases, “unauthenticated” may be stored.

In the foregoing first exemplary embodiment, the first authentication unit 507 and the second authentication unit 508 both use eye image-based personal authentication. However, the first and second authentication units 507 and 508 may be configured to use other authentication methods. For example, other biometric authentications such as fingerprint authentication may be used for the first authentication. Fingerprint authentication can be implemented by incorporating a fingerprint sensor in the release button 121 and performing authentication when the user puts the finger on the release button 121. Multi-stage biometric authentication using a plurality of pieces of biological information may be performed as the first authentication. In such a case, the pieces of biological information used for the first and second authentications are limited to those of which whether acquired from the same person can be determined, or those which are guaranteed to be manually acquired from the same person. Example of the biological information of which whether acquired from the same person can be determined include fingerprints of different fingers, since fingerprints of different fingers have relevance if they are acquired from the same person. For that purpose, a neural network is used that has been trained to be able to determine whether pieces of fingerprint data are acquired from the same person by using fingerprint data acquired from different fingers as training data. This enables determination of whether the fingerprint data used in the first authentication and that used in the second authentication are acquired from the same person. With such a determination, both the first and second authentications may be performed through fingerprint authentication. As another example of the biological information of which whether acquired from the same person can be determined, the first authentication may be performed through facial authentication, and the second authentication through personal authentication using an eye image. In such a case, a neural network is used that has been trained to be able to make determination based on the identity of an eye region included in the facial image used in the first authentication and the eye image used in the second authentication. Since the second authentication is performed at imaging time, the second authentication unit 508 is desirably capable of authentication during imaging. For example, with a fingerprint sensor incorporated in the release button 121, fingerprint authentication can be performed at imaging time and used for the second authentication. Imaging is sometimes performed by displaying an image being captured by the image sensor 211 on the touchscreen (operation member 123), without the user looking into the viewfinder. In such an imaging mode, facial authentication can be used for the second authentication. To control the authentication state of the second authentication to last only during imaging, in the case of using facial authentication, imaging may be regarded as being in progress while the face is captured. Alternatively, in the case of fingerprint authentication, imaging may be regarded as being in progress while the finger is put on the release button 121.

When the first authentication succeeds, the features of the eye image at that time or before or after that time may be retained for use. During the second authentication, authentication through identity check (verification processing) with the features upon the foregoing successful first authentication may be performed. Such a method has the advantage of reducing the effort to register images intended for the second authentication. This method is effective when the second authentication is desirably performed in an environment significantly different from during registration. The foregoing identity check and the foregoing other matching may be both performed for improved reliability.

More specifically, if matching by either means succeeds (or matching by both means succeeds), the second authentication may be determined to be successful. Other modes of application of this method may include the following. During the first authentication, a personal identification number (PIN) is input and the fingerprint authentication using the release button 121 is performed. If the first authentication succeeds, the facial image of the user is simultaneously captured using the in-camera and converted into a feature amount, and the feature amount is stored. For the second authentication, the identity of the features of the facial image and the facial features of the photographer is checked.

In such a manner, there are various possible modes for two-stage authentication through the application of the first exemplary embodiment.

In the foregoing first exemplary embodiment, the first authentication state invalidation unit 510 invalidates the first authentication state when various conditions apply. However, when the first authentication state is invalidated, the user can validate the first authentication state by performing the first authentication again. The successful first authentication and the invalidation of the first authentication state can therefore be repeatedly for the purpose of unauthorized use. In view of this, the camera 100 may include a not-illustrated first authentication restriction unit. This first authentication restriction unit detects suspicion of unauthorized use and imposes restriction so that the first authentication is temporarily unable to be performed. As for the detection method, the first authentication restriction unit detects suspicion of unauthorized use when the successful first authentication by the first authentication unit 507 and the invalidation of the first authentication state by the first authentication state invalidation unit 510 are repeated within a predetermined period. Alternatively, the detection of suspicion may be limited to only some of the foregoing various conditions based on which the first authentication state is invalidated. For example, the detection of suspicion may be limited to the invalidation of the first authentication state by the first authentication state invalidation unit 510 when another person's use is suspected by the other person use detection unit 509. More specifically, the suspicion of unauthorized use is detected when the invalidation due to the detection of another person's use and the successful first authentication by the first authentication unit 507 are repeated within a predetermined period. A possible method for restricting the execution of the first authentication is to disable user operation on the menu. In other words, if the camera 100 is configured so that the user operates the camera 100 to call the first authentication processing from a menu, the menu for calling the first authentication processing can be disabled. The restricted state may be canceled after a lapse of a certain time. This makes it difficult for the registered person to deliberately lend the camera 100 to another person and have them capture images. In particular, if techniques other than biometric authentication are used for the first authentication, the first authentication can be performed even in the absence of the registered person. For example, the first authentication can be successfully performed by sharing a password and PIN or by lending a paired smartphone as well. The foregoing restriction can prevent such unauthorized use.

In the first exemplary embodiment, the second authentication by the second authentication unit 508 is performed at imaging time (during imaging). However, authentication may be difficult to perform at imaging time because of speed and other resources. In such a case, the information necessary for the second authentication may be stored at imaging time, and the authentication processing may be performed after the imaging. For example, an eye image may be stored at imaging time and authenticated may be performed after the imaging. Similarly, biological information (facial image, fingerprint) may be stored for other biometric authentication (face authentication, fingerprint authentication). In the case of determination based on the connection state between a smartphone and the camera 100, connection state parameters may be stored, and the processing for analyzing the connection state for authentication may be performed afterward. The second authentication thus does not necessarily need to be performed at imaging time. The information necessary for the second authentication may be acquired at imaging time and authenticated after the imaging.

In performing authentication afterward, the authentication result may not be obtained in time with the storage of the image file 1200. In such a case, an option different from “authenticated” and “unauthenticated” may be provided for the second authentication state like “in process”, and stored as the photographer information 1211 of the metadata 1210. The photographer information 1211 of the metadata 1210 may be modified and stored again when the authentication result of the second authentication is obtained. The second authentication desirably uses biometric authentication. Input actions such as password input are difficult for the photographer to perform at imaging time. Authentication based on the connection state between a smartphone and the camera 100 has room for another person's use if the user lends the smartphone along with the camera 100. By contrast, biometric authentication does not need an action for authentication, and the information can only be possessed by the same person. Biometric authentication is thus desirably used for the second authentication performed at imaging time.

In the foregoing first exemplary embodiment, the second authentication is performed when the first authentication state is “authenticated”. However, there may be cases where the first authentication is difficult to perform, such as when the user suddenly needs to capture an image or when the user has forgotten the first authentication. The camera 100 then may be configured so that the second authentication is performed with the first authentication state “unauthenticated”. Specifically, step S901 of FIG. 9, from which the processing proceeds to step S902 only when the first authentication state is “authenticated”, may be modified so that the processing also proceeds to step S902 when the first authentication state is “unauthenticated”. When the first authentication state is “unauthenticated”, the personal ID in the authentication state table 570 of FIG. 5F has a null value. If the second authentication succeeds with the first authentication state “unauthenticated”, then in step S911 of FIG. 9, the personal ID in the authentication state table 570 can be updated with the personal ID identified in step S909 of FIG. 9. If follows that in the authentication state storage processing, the first authentication state “unauthenticated” and the second authentication state “authenticated” are stored in the photographer information 1211 of the metadata 1210. Here, the personal ID can be stored in the photographer information 1211 of the metadata 1210 so that it is shown that the personal ID is one identified by the second authentication. For example, the personal ID may be recorded as another metadata item. In the foregoing description, if there is not one but more than one registered person, the feature vectors to be acquired in in step S908 of FIG. 9 illustrating the second authentication are described to be limited to those with the personal ID identified by the first authentication. However, if the first authentication has not been performed, all the feature vectors in the second authentication registered feature vector table 560 are extracted in step S908 of FIG. 9 and collated in step S909 of FIG. 9. Here, the personal ID of a feature vector with a similarity exceeding a threshold is authenticated. If there is a plurality of personal ID with similarities exceeding the threshold, the personal ID of the most similar feature vector is authenticated. Alternatively, the authentication may be ended with a failure. Different thresholds may be used in step S909 of FIG. 9 depending on whether the first authentication state is “authenticated” or “unauthenticated”. Alternatively, other authentication settings such as the model to be used may be changed. The reason is that the optimum settings are different since the 1:1 authentication problem is now a 1:N authentication problem.

In the foregoing first exemplary embodiment, the second authentication is processed on the assumption that the personal ID is the same as that identified by the first authentication. However, the personal ID may be independently identified in the second authentication instead of using the result of the first authentication. Specifically, the authentication state table 570 of FIG. 5F managed by the authentication state management unit 521 is modified to store the “personal ID of the first authentication” and the “personal ID of the second authentication” separately. Respective personal IDs then can be stored for the first authentication and the second authentication. In step S908 of FIG. 9 illustrating the second authentication processing, the feature vectors to be acquired are limited to those with the personal ID of the first authentication. Instead, the second authentication unit 508 may be configured to identify personal IDs from all the feature vectors. In storing the metadata 1210 in FIG. 12A illustrating the authentication state storing processing, the personal IDs and the authentication states of the first and second authentications may be all stored separately in the metadata 1210. In using the metadata 1210, that the same person is authenticated by the first authentication and the second authentication can be checked to confirm that the image is captured by the same person. Alternatively, if the personal IDs of the first and second authentications are different in storing the metadata 1210 in FIG. 12A illustrating the authentication state storage processing, the second authentication state may be stored as “unauthenticated”. In such a case, the personal information (i.e., name) related to the personal ID of the first authentication is stored as the photographer information 1211 (i.e., name) in the metadata 1210. The processing for identifying that the same person is authenticated by the first authentication and the second authentication may be performed when the metadata 1210 is stored. In such a manner, the first authentication and the second authentication may be performed independently, and that the persons are the same may be checked in referring to the authentication results of the first and second authentications.

In the foregoing first exemplary embodiment, the first authentication is performed at non-imaging time, and the second authentication is performed at imaging time. However, that the photographer is a registered user may be guaranteed based only on the authentication result of the first authentication without performing the second authentication. Specifically, that the photographer is a registered user is guaranteed without performing the second authentication until a predetermined time elapses since the success of the first authentication.

In the foregoing first exemplary embodiment, the registration processing and the first authentication processing include performing the left and right eye determination processing based on a discrepancy between the actual point of fixation and the estimated point of fixation in the line of sight detection processing. However, the left and right eyes may be determined by the user inputting which of the left and right eyes to acquire an eye image of, without performing the left and right eye detection processing. Specifically, before the acquisition of eye images in step S604 of FIG. 6A and step S617 of FIG. 6B in the registration processing, the left and right eyes are determined by the user specifying which eye to look into the viewfinder with by user operation on a menu. Alternatively, before the acquisition of eye images in step S803 of FIG. 8A and step S814 of FIG. 8B in the first authentication processing, the left and right eyes are determined by the user specifying which eye to look into the viewfinder with by user operation on a menu. Alternatively, the left and right eyes may be determined by instructing the user about which of the left and right eyes to acquire an eye image of, without performing the left and right eye determination processing. Specifically, in displaying the instructions about the authentication method in steps S801 and S812 of FIG. 8A in the first authentication processing, instructions about which of the left and right eyes to look into the viewfinder with are also displayed for left and right eye determination. Alternatively, the left and right eyes may be determined based on which of the left and right eyes the feature vector of the highest similarity with the feature vector to be collated is acquired from, without performing the left and right eye determination processing. Specifically, in performing collation in step S808 of FIG. 8A in the first authentication processing, the feature vectors are acquired from both the first authentication registered right eye feature vector table 540 illustrated in FIG. 5C and the first authentication registered left eye feature vector table 550 illustrated in FIG. 5D, and subjected to the collation. If the feature vector of the highest similarity is acquired from the first authentication registered right eye feature vector table 540, the eye image is determined to be one acquired from the right eye. Similarly, if the feature vector of the highest similarity is acquired from the first authentication registered left eye feature vector table 550, the eye image is determined to be one acquired from the left eye.

A second exemplary embodiment will be described. In the following description of the second exemplary embodiment, a description of items similar to those of the foregoing first exemplary embodiment will be omitted, and differences from the foregoing first exemplary embodiment will be described.

In the foregoing first exemplary embodiment, the first authentication is not determined to be successful unless both the authentications using the plurality of pieces of biological information (both eyes) succeed. In the second exemplary embodiment, if the strictness desired of the collation is not high and the authentication with one of the left and right eyes succeeds, the first authentication is determined to be successful. As an example of the second exemplary embodiment, a rental apparatus that is a rented head-mounted display (HMD) will be assumed. For example, the strictness desired of the collation in logging in to the HMD is not high, and the user is permitted to log in if authentication with one of the left and right eyes succeeds. By contrast, in a case of online payment via the HMD, the strictness desired of the collation is high, and the user is unable to make payment unless the authentications with both left and right eyes succeed. The operations to be permitted by the first authentication are not limited thereto.

A modification of the second exemplary embodiment will be described. In the foregoing second exemplary embodiment, in situations where the strictness desired of the collation is not high, the first authentication is determined to be successful if authentication with one of the left and right eyes succeeds, and determined to be failed if authentication with the one eye fails. However, the first authentication may be determined to be successful if authentication with the one eye fails and authentication with the other eye succeeds.

An exemplary embodiment of the present disclosure can also be implemented by processing for supplying a program for implementing one or more functions of the foregoing exemplary embodiments to a system or an apparatus, and reading and executing the program by one or more processors in a computer of the system or apparatus. Circuits for implementing one or more functions (such as an application-specific integrated circuit [ASIC]) can also be used for implementation.

The program and a computer-readable storage medium storing the program are included in an exemplary embodiment of the present disclosure.

The foregoing exemplary embodiments of the present disclosure are all merely examples of specific implementation for carrying out the present disclosure, and the technical scope of the present disclosure shall not be interpreted as limited thereto. In other words, the present disclosure can be implemented in various forms without departing from the technical concept or main features thereof.

According to an exemplary embodiment of the present disclosure, the accuracy of user authentication by an information processing apparatus can be improved and a decrease in usability can be prevented.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-114159, filed Jul. 17, 2024, which is hereby incorporated by reference herein in its entirety.

What is claimed is:

1. An information processing apparatus configured to perform user authentication, the information processing apparatus comprising:
one or more memories storing instructions; and
one or more processors that, upon execution of the stored instructions, are configured to operate as:
a management unit that manages authentication registration information about a user to permit use of the information processing apparatus; and
an authentication unit that performs authentication of an authentication target user by using a plurality of pieces of authentication target information acquired from a plurality of different parts of the authentication target user seeking to use the information processing apparatus and the authentication registration information.

2. The information processing apparatus according to claim 1, wherein the plurality of pieces of authentication target information is a plurality of pieces of biological information acquired from the plurality of parts of a body of the authentication target user.

3. The information processing apparatus according to claim 2, wherein the plurality of pieces of biological information is feature information based on eye images acquired from right and left eyes of the authentication target user.

4. The information processing apparatus according to claim 3, wherein execution of the stored instructions further configures the one or more processor to operate as a determination unit that determines the eye image of the right eye and the eye image of the left eye based on a discrepancy between a line of sight of the authentication target user estimated from the eye images and an actual line of sight of the authentication target service.

5. The information processing apparatus according to claim 1, wherein the authentication unit performs, after first authentication succeeds, second authentication on the authentication target user by using authentication target information acquired from one of the plurality of parts of the authentication target user, the first authentication being the authentication of the authentication target user using the plurality of pieces of authentication target information.

6. The information processing apparatus according to claim 5, wherein the authentication unit performs the first authentication before the authentication target user performs imaging, and performs the second authentication while the authentication target user is performing imaging.

7. The information processing apparatus according to claim 5, wherein the authentication unit determine that the first authentication is successful when the first authentication succeeds in authentication using at least one of the plurality of pieces of authentication target information.

8. The information processing apparatus according to claim 5, wherein the management unit manages the authentication registration information associated with the user for use in each of the first authentication and second authentication in association with each other.

9. The information processing apparatus according to claim 5, wherein execution of the stored instructions further configures the one or more processors to comprising an execution unit configured to execute predetermined processing based on authentication states of the first authentication and the second authentication.

10. The information processing apparatus according to claim 9, wherein the execution unit is configured to execute at least one of management processing, storage processing, and display processing of the authentication states of the first authentication and the second authentication as the predetermined processing.

11. The information processing apparatus according to claim 9, wherein the execution unit is configured to change a content of the predetermined processing based on the authentication states of the first authentication and the second authentication.

12. A method for controlling an information processing apparatus configured to perform user authentication, the method comprising:
managing authentication registration information about a user to permit use of the information processing apparatus; and
performing authentication of an authentication target user by using a plurality of pieces of authentication target information acquired from a plurality of different parts of the authentication target user seeking to use the information processing apparatus and the authentication registration information.

13. A non-transitory computer readable storage medium storing a program that when executed by one or more processors, configures a computer to function as:
a management unit that manages authentication registration information about a user to permit use of the information processing apparatus; and
an authentication unit that performs authentication of an authentication target user by using a plurality of pieces of authentication target information acquired from a plurality of different parts of the authentication target user seeking to use the information processing apparatus and the authentication registration information.
